(19) United States
(12) Patent Application Publication
(10) Pub. No.: US 2026/0279757 A1
(43) Pub. Date: Sep. 17, 2026

(54) SECONDARY BATTERY AND ELECTRIC APPARATUS

(71) Applicant: Ningde Amperex Technology Limited, Ningde (CN)

(72) Inventor: Jun HE, Ningde (CN)

(73) Assignee: Ningde Amperex Technology Limited, Ningde (CN)

(21) Appl. No.: 19/671,897

(22) Filed: May 8, 2026

Related U.S. Application Data
(63) Continuation of application No. PCT/CN2023/130754, filed on Nov. 9, 2023.

(51) Int. Cl. H01M 4/00; H01M 4/02; H01M 10/0567; H01M 10/0569; H01M 50/414; H01M 50/443; H01M 50/457

(52) U.S. Cl. CPC H01M 4/00; H01M 10/0567; H01M 10/0569; H01M 50/414; H01M 50/443; H01M 50/457; H01M 2004/021; H01M 2004/027; H01M 2004/028

(57) ABSTRACT

A secondary battery includes a positive electrode sheet including a positive electrode active material, and a negative electrode sheet including a negative electrode active material, where Dᵥ99 of the positive electrode active material is 27 μm to 33 μm, and Dᵥ99 of the negative electrode active material is 23 μm to 28 μm; a separator includes a separator substrate, a first adhesive coating and a second adhesive coating, where the first adhesive coating and the second adhesive coating are respectively provided on two sides of the separator substrate, the first adhesive coating includes a first polymer binder, an average particle size of the first polymer binder is 0.3 μm to 3 μm, the second adhesive coating includes a second polymer binder, and an average particle size of the second polymer binder is 10 μm to 38 μm; and an electrolyte includes an organic solvent, a lithium salt, and an additive.

### CROSS REFERENCE TO THE RELATED APPLICATIONS

This application is a continuation application of International Application No. PCT/CN2023/130754, filed on Nov. 9, 2023, the contents of which are incorporated herein by reference in its entirety.

### TECHNICAL FIELD

The present application relates to the field of electrochemical technology, in particular to a secondary battery and an electric apparatus.

### BACKGROUND

Secondary batteries (such as lithium-ion batteries) have characteristics such as high specific energy, high operating voltage, low self-discharge rate, small size, and light weight, and are widely used in various fields such as electrical energy storage, portable electronic devices, and electric vehicles. With the continuous iterative development of consumer lithium-ion batteries in recent years, the market has imposed increasingly high requirements on their charging speed, the charging rate of lithium-ion batteries is continuously increasing, and consumer demand has gradually increased from 1 C to above 5 C. However, for superfast-charge (5° C.≤charging rate≤15 C) lithium-ion batteries, it is difficult to guarantee both the charging rate and high-temperature (temperature≥60° C.) stability. Therefore, how to guarantee the high-temperature stability of lithium-ion batteries while improving the cycling kinetic performance of the lithium-ion batteries has become an urgent technical problem to be solved by those skilled in the art.

### SUMMARY

The present application is intended to provide a secondary battery, to guarantee high-temperature stability of the secondary battery while improving the cycling kinetic performance of the secondary battery, and further provide an electric apparatus using such secondary battery.

It should be noted that in the summary of the present application, the lithium-ion battery is used as an example of the secondary battery to explain the present application, but the secondary battery of the present application is not limited to lithium-ion batteries, and may alternatively be a secondary battery such as a sodium-ion battery. The specific technical solution is as follows.

According to a first aspect, the present application provides a secondary battery, where the secondary battery includes an electrode assembly and an electrolyte. The electrode assembly includes a positive electrode sheet, a negative electrode sheet, and a separator. The positive electrode sheet includes a positive electrode active material, and the negative electrode sheet includes a negative electrode active material, where Dᵥ99 of the positive electrode active material is 27 μm to 33 μm, and Dᵥ99 of the negative electrode active material is 23 μm to 28 μm. The separator includes a separator substrate, a first adhesive coating, and a second adhesive coating. The first adhesive coating and the second adhesive coating are respectively provided on two sides of the separator substrate. The first adhesive coating includes a first polymer binder, where an average particle size of the first polymer binder is 0.3 μm to 3 μm. The second adhesive coating includes a second polymer binder, where an average particle size of the second polymer binder is 10 μm to 38 μm. The electrolyte includes an organic solvent, a lithium salt, and an additive. The organic solvent includes a linear carboxylate ester; and based on a mass of the electrolyte, a mass percentage of the linear carboxylate ester is 6% to 56%. In the present application, by adjusting the Dᵥ99 of the positive electrode active material and the negative electrode active material within the above ranges, lithium ions have a short transmission path inside the positive/negative electrode active material during a transmission process and a small transmission tortuosity inside the positive/negative electrode sheet, so as to reduce concentration polarization of the secondary battery, thereby making the secondary battery have good cycling kinetic performance. In the present application, by adjusting the mass percentage of the linear carboxylate ester in the electrolyte within the above range, lithium ions have a high transmission speed in the electrolyte, so as to reduce the electrochemical polarization and concentration polarization of the secondary battery, reduce the impedance of the secondary battery, and reduce a charging temperature rise and shorten a charging time during fast charging of the secondary battery, thereby making the secondary battery have good cycling kinetic performance and fast-charging performance. That is, through the high kinetic performance design for the particle sizes of the positive and negative electrode materials and the electrolyte composition, a high-rate chemical system of the secondary battery is ensured. However, the high kinetic performance design makes side reactions easy to take place between the positive and negative electrode active materials and the electrolyte. Especially, intense side reactions take place at high temperatures to generate a large amount of gas, resulting in poor high-temperature performance of the secondary battery. In the present application, a first adhesive coating and a second adhesive coating are respectively provided on two sides of the separator, and the average particle size of the first polymer binder in the first adhesive coating and the average particle size of the second polymer binder in the second adhesive coating are within the above ranges provided in the present application, a side of the separator where the first adhesive coating is provided has high adhesion strength, which can enhance the adhesion strength between the separator and the positive/negative electrode sheet, enhance an interface between the separator and the positive/negative electrode sheet, inhibit gas generation under high-temperature conditions, and reduce the probability of swelling of the secondary battery due to excessive gas generation, thereby improving the high-temperature stability. In a side of the separator where the second adhesive coating is provided, electrolyte flow channels may be generated to store the electrolyte, meeting the requirements of the secondary battery for high liquid retention capacity (such as 1.5 g/Ah to 2.4 g/Ah) and high transmission and infiltration performance of the electrolyte in a superfast charging state, thereby ensuring the rate performance and cycling performance of the secondary battery. In the present application, the separator, the Dᵥ99 of the positive electrode active material, the Dᵥ99 of the negative electrode active material, and the electrolyte are combined to play a good synergistic effect, thereby guaranteeing the high-temperature stability of the secondary battery while improving the cycling kinetic performance of the secondary battery.

In an embodiment of the present application, the Dᵥ99 of the positive electrode active material is 28 μm to 31 μm, and/or the Dᵥ99 of the negative electrode active material is 24 μm to 26 μm. By adjusting the Dᵥ99 of the positive electrode active material and/or the negative electrode active material within the above ranges, the range of the Dᵥ99 of the positive electrode active material and/or the negative electrode active material is more appropriate, helping to further improve the cycling kinetic performance and high-temperature stability of the secondary battery.

In an embodiment of the present application, the average particle size of the first polymer binder is 0.6 μm to 1.6 μm; and/or the average particle size of the second polymer binder is 20 μm to 30 μm. Adjusting the average particle size of the first polymer binder and/or the average particle size of the second polymer binder within the above ranges helps to make the secondary battery have high energy density while guaranteeing both the cycling kinetic performance and high-temperature stability.

In an embodiment of the present application, the Dᵥ50 of the positive electrode active material is 10 μm to 15 μm, and the Dᵥ50 of the negative electrode active material is 7 μm to 12 μm. Adjusting the Dᵥ50 of the positive electrode active material and the negative electrode active material within the above ranges helps to make the secondary battery have high energy density while having good cycling kinetic performance and high-temperature stability.

In an embodiment of the present application, the first adhesive coating is provided on a side of the separator substrate close to the negative electrode sheet, and the second adhesive coating is provided on a side of the separator substrate close to the positive electrode sheet. By setting positional relationships between the first and second adhesive coatings in the separator and the negative and positive electrode sheets, the secondary battery has further improved cycling kinetic performance while having good high-temperature stability. In addition, for most secondary batteries, the main requirement is fast charge for energy replenishment, but there is no demand for fast discharge, that is, a charging rate is much greater than a discharging rate. A charging process of the secondary battery mainly involves intercalation of lithium ions into a negative electrode. Therefore, the provision of the first adhesive coating with smaller particles on the separator on a side of the negative electrode sheet can shorten a lithium ion transmission path during the charging process, thereby achieving a higher charging speed.

In an embodiment of the present application, a thickness of the first adhesive coating is 0.2 μm to 4 μm, and a thickness of the second adhesive coating is 5 μm to 20 μm. The first adhesive coating has a smaller particle size and higher adhesion strength. Ensuring its thickness to be 0.2 μm to 4 μm can maximize the energy density while ensuring the adhesion strength, as well as shorten the transmission path of lithium ions in an active material layer corresponding to the first adhesive coating. The second adhesive coating has a larger particle size and can form electrolyte flow channels. Setting its thickness between 5 μm and 20 μm can increase the energy density while ensuring the flow and infiltration of the electrolyte.

In an embodiment of the present application, a single-side coating weight of the first adhesive coating is 0.0001 mg/mm² to 0.001 mg/mm², and a single-side coating weight of the second adhesive coating is 0.0004 mg/mm² to 0.002 mg/mm². Adjusting the single-side coating weight of the first adhesive coating within the above range can fully exert the high adhesion characteristic of the first adhesive coating, so that the electrode sheet and the separator are better adhered, thereby ensuring the high-temperature stability and mechanical reliability of the secondary battery. Adjusting the single-side coating weight of the second adhesive coating within the above range can fully realize formation of the electrolyte flow channel between the electrode sheet and the separator, thereby improving the kinetic performance and cycling characteristics of the secondary battery.

In an embodiment of the present application, a coverage rate of the first polymer binder in the first adhesive coating per unit area is 40% to 60%. Adjusting the coverage rate of the first polymer binder in the first adhesive coating per unit area within the above range can make the secondary battery have low production costs while guaranteeing both the cycling kinetic performance and high-temperature stability, fully exert the high adhesion characteristic of the first adhesive coating, and achieve a high transmission speed of lithium ions while facilitating the adhesion between the separator and the electrode sheet, thereby further helping to make the secondary battery have good kinetic performance.

In an embodiment of the present application, the first polymer binder is a core-shell structure. The first polymer binder includes a first shell and a first core, where a polymerization monomer of the first shell includes at least one of methyl acrylate, ethyl acrylate, butyl acrylate, methyl methacrylate, ethyl methacrylate, butyl methacrylate, ethylene, ethyl chloromethyl acrylate, chlorostyrene, fluorostyrene, methylstyrene, acrylonitrile, or methacrylonitrile, and a polymerization monomer of the first core includes at least one of ethyl acrylate, butyl acrylate, ethyl methacrylate, styrene, chlorostyrene, fluorostyrene, methylstyrene, acrylic acid, methacrylic acid, or maleic acid; or, the first polymer binder is a non-core-shell structure, where a polymerization monomer of the first polymer binder includes at least one of acrylic acid, methyl acrylate, butyl acrylate, butadiene, styrene, acrylonitrile, ethylene, fluorostyrene, chlorostyrene, or propylene. Applying the above types of first polymer binders to the first adhesive coating can make the first adhesive coating have high adhesion strength.

In an embodiment of the present application, a coverage rate of the second polymer binder in the second adhesive coating per unit area is 40% to 60%. By adjusting the coverage rate of the second polymer binder in the second adhesive coating per unit area within the above range, the second polymer binder enables a large gap between the second adhesive coating and the positive electrode sheet or negative electrode sheet, which can fully realize formation of electrolyte flow channels between the electrode sheet and the separator. Under a condition that the electrolyte has good flow and infiltration in the electrode sheet and the separator, the second adhesive coating has an appropriate thickness, thereby reducing the risk of energy density loss caused by volume increase of a fast-charge secondary battery due to excessive thickness. Thus, the secondary battery can have low production costs and high energy density while guaranteeing both the cycling kinetic performance and high-temperature stability.

In an embodiment of the present application, the second polymer binder is a core-shell structure. The second polymer binder includes a second shell and a second core, where a polymerization monomer of the second shell includes at least one of vinylidene chloride, vinylidene fluoride, hexafluoropropylene, styrene, butadiene, acrylonitrile, acrylic acid, methyl acrylate, or butyl acrylate, and a polymerization monomer of the second core includes at least one of ethyl methacrylate, methyl acrylate, ethyl acrylate, butyl acrylate, methyl methacrylate, butyl methacrylate, or ethyl chloromethyl acrylate; or, the second polymer binder is a non-core-shell structure, where a polymerization monomer of the second polymer binder includes at least one of vinylidene chloride, vinylidene fluoride, hexafluoropropylene, ethylene, propylene, vinyl chloride, chloropropene, acrylic acid, methyl acrylate, butyl acrylate, styrene, butadiene, or acrylonitrile. Use of the above types of second polymer binders enables a large gap between the second adhesive coating and the positive/negative electrode sheet.

In an embodiment of the present application, the linear carboxylate ester includes at least one of methyl formate, methyl acetate, ethyl formate, ethyl acetate, propyl acetate, ethyl propionate, methyl propionate, n-propyl propionate, isopropyl propionate, n-butyl propionate, isobutyl propionate, n-pentyl propionate, isopentyl propionate, ethyl butyrate, n-propyl butyrate, propyl isobutyrate, n-pentyl butyrate, n-pentyl isobutyrate, n-butyl butyrate, isobutyl isobutyrate, or n-pentyl valerate. The above types of linear carboxylate esters have high conductivity and low viscosity, facilitating lithium ion transmission. Use of the above types of linear carboxylate esters can make the secondary battery have good cycling kinetic performance and high-temperature stability.

In an embodiment of the present application, based on the mass of the electrolyte, a mass percentage of the linear carboxylate ester is 18% to 40%. By adjusting the mass percentage of the linear carboxylate ester within the above range, lithium ions have a higher transmission speed in the electrolyte, thereby further improving the cycling kinetic performance of the secondary battery while the secondary battery has good high-temperature stability.

In an embodiment of the present application, the organic solvent further includes at least one of ethylene carbonate, propylene carbonate, dimethyl carbonate, diethyl carbonate, methyl ethyl carbonate, γ-butyrolactone, or tetrahydrofuran. Based on the mass of the electrolyte, a mass percentage of the organic solvent is 60% to 90%. Further using the above organic solvents and adjusting the mass percentage of the organic solvent within the above range helps to make the secondary battery have good cycling kinetic performance and high-temperature stability.

In an embodiment of the present application, the additive includes at least one of succinonitrile, glutaronitrile, pimelonitrile, 1,2-bis(2-cyanoethoxy) ethane, 1,2-bis(2-cyanoethoxy) propane, or 1,2-(3-cyanopropoxy) ethane. Based on the mass of the electrolyte, a mass percentage of the additive is 2% to 20%.

In an embodiment of the present application, the negative electrode active material includes at least one of a carbon-based material, a silicon-based material, or a tin-based material. The carbon-based material includes at least one of natural graphite, artificial graphite, soft carbon, hard carbon, or mesocarbon microbeads. The silicon-based material includes at least one of elemental silicon, a silicon-carbon material, or a silicon-oxygen material. The tin-based material includes at least one of elemental tin, tin alloy, or tin oxide. The above types of negative electrode active materials have high surface activity, which can make the secondary battery have good cycling kinetic performance while having high-temperature stability.

In an embodiment of the present application, a peak intensity ratio I_{d}/I_{g} of peak d to peak g in a Raman test of the carbon-based material satisfies: 0.2≤I_{d}/I_{g}≤1.0. Applying a carbon-based material with the above I_{d}/I_{g} value to the secondary battery helps to further improve the cycling kinetic performance of the secondary battery while the secondary battery has good high-temperature stability.

In an embodiment of the present application, the positive electrode active material includes at least one of lithium nickel cobalt manganese oxide, lithium nickel cobalt aluminum oxide, lithium iron phosphate, a lithium-rich manganese-based material, lithium cobalt oxide, lithium manganese oxide, lithium manganese iron phosphate, or lithium titanate. The above types of positive electrode active materials have high surface activity, which can make the secondary battery have good cycling kinetic performance while having high-temperature stability.

In an embodiment of the present application, the positive electrode active material further includes a non-metal element, and the non-metal element includes at least one of fluorine, phosphorus, boron, chlorine, silicon, or sulfur. When the positive electrode active material includes the above types of non-metal elements, the stability of the positive electrode active material can be further improved.

According to a second aspect, the present application provides an electric apparatus, which includes the secondary battery described in any one of the foregoing embodiments. Therefore, the electric apparatus has good use performance.

The beneficial effects of the present application are as follows.

The present application provides a secondary battery and an electric apparatus, where in the secondary battery, the Dᵥ99 of the positive electrode active material, the Dᵥ99 of the negative electrode active material, and the mass percentage of the linear carboxylate ester in the electrolyte are adjusted within the ranges provided in the present application, a first adhesive coating and a second adhesive coating are respectively provided on two sides of the separator, and an average particle size range of the first polymer binder in the first adhesive coating and an average particle size range of the second polymer binder in the second adhesive coating are limited within the above ranges provided in the present application, so that the separator, the positive electrode active material, the negative electrode active material, and the electrolyte play a good synergistic effect, and lithium ions have a short transmission path inside the positive electrode active material and the negative electrode active material, a small transmission tortuosity inside the positive electrode sheet and the negative electrode sheet, and a high transmission speed in the electrolyte, reducing concentration polarization and electrochemical polarization of the secondary battery and achieving a wide electrolyte flow channel and high interface adhesion strength between the separator and the positive electrode sheet or negative electrode sheet, thereby guaranteeing the high-temperature stability of the secondary battery while improving the cycling kinetic performance of the secondary battery. The electric apparatus of the present application has good use performance.

### DESCRIPTION OF DRAWINGS

The drawings described herein are used to provide further understanding of the present application and constitute a part of the present application. The schematic embodiments of the present application and descriptions thereof are used to explain the present application and do not constitute any improper limitation on the present application.

FIG. 1 is a schematic diagram of positional relationships between a separator and positive and negative electrode sheets according to an embodiment of the present application;

FIG. 2 is a schematic diagram of positional relationships between a separator and positive and negative electrode sheets according to another embodiment of the present application;

FIG. 3 is a schematic structural cross-sectional view of a separator along its thickness direction according to an embodiment of the present application;

FIG. 4 is a schematic structural cross-sectional view of a separator along its thickness direction according to another embodiment of the present application;

FIG. 5 is a schematic structural cross-sectional view of a separator along its thickness direction according to still another embodiment of the present application; and

FIG. 6 is a Raman spectrum of a negative electrode in Example 3-3.

### DETAILED DESCRIPTION

In order to make the objectives, technical solutions, and advantages of the present application clearer, the present application is further described in detail below with reference to the drawings and embodiments. Obviously, the described embodiments are only some embodiments rather than all embodiments of the present application. All other embodiments obtained by those skilled in the art based on the present application fall within the protection scope of the present application.

It should be noted that in specific embodiments of the present application, a lithium-ion battery is used as an example of the secondary battery to explain the present application, but the secondary battery of the present application is not limited to lithium-ion batteries, and may alternatively be a secondary battery such as a sodium-ion battery.

According to a first aspect, the present application provides a secondary battery, where the secondary battery includes an electrode assembly and an electrolyte. The electrode assembly includes a positive electrode sheet, a negative electrode sheet, and a separator. The separator is provided between the positive electrode sheet and the negative electrode sheet to separate the positive electrode sheet from the negative electrode sheet. The positive electrode sheet includes a positive electrode active material, and the negative electrode sheet includes a negative electrode active material, where Dᵥ99 of the positive electrode active material is 27 μm to 33 μm, and Dᵥ99 of the negative electrode active material is 23 μm to 28 μm. The separator includes a separator substrate, a first adhesive coating, and a second adhesive coating. The first adhesive coating and the second adhesive coating are respectively provided on two sides of the separator substrate. The first adhesive coating includes a first polymer binder, where an average particle size of the first polymer binder is 0.3 μm to 3 μm. The second adhesive coating includes a second polymer binder, where an average particle size of the second polymer binder is 10 μm to 38 μm. The electrolyte includes an organic solvent, a lithium salt, and an additive. The organic solvent includes a linear carboxylate ester; and based on a mass of the electrolyte, a mass percentage of the linear carboxylate ester is 6% to 56%.

For example, the Dᵥ99 of the positive electrode active material is 27 μm, 28 μm, 29 μm, 30 μm, 31 μm, 32 μm, 33 μm, or any value within a range defined by any two of these values. If the Dᵥ99 of the positive electrode active material is less than 27 μm, the Dᵥ99 of the positive electrode active material is too small, indicating that a volume-based particle size of the positive electrode active material particles is too small. Thus, during preparation of a positive electrode slurry, positive electrode active material particles are prone to agglomeration. This results in an extremely small probability of uniform distribution of the positive electrode active material in the positive electrode slurry, and non-uniform distribution of the positive electrode active material particles in the formed positive electrode active material layer affects the processing stability of the positive electrode sheet and causes the problem of uneven coating during a coating process of the positive electrode slurry. Moreover, a specific surface area of the positive electrode active material particles is too large, leading to an increase in interfaces between the positive electrode active material particles and the electrolyte, and intensifying side reactions. Especially in a superfast-charge high-kinetic-performance electrolyte system, side reactions are very intense, accelerating electrolyte consumption and generation of side reaction products, thereby deteriorating the cycling performance and high-temperature stability of the secondary battery. If the Dᵥ99 of the positive electrode active material is greater than 33 μm, the Dᵥ99 of the positive electrode active material is too large, the transmission path of lithium ions inside the positive electrode active material particles is too long, and the transmission tortuosity inside the positive electrode sheet is too large, leading to excessive concentration polarization inside the secondary battery, thereby increasing the internal resistance of the secondary battery and reducing the cycling kinetic performance of the secondary battery.

For example, the Dᵥ99 of the negative electrode active material is 23 μm, 24 μm, 25 μm, 26 μm, 27 μm, 28 μm, or any value within a range defined by any two of these values. If the Dᵥ99 of the negative electrode active material is less than 23 μm, the Dᵥ99 of the negative electrode active material is too small, indicating that a volume-based particle size of the negative electrode active material particles is too small. During preparation of a negative electrode slurry, negative electrode active material particles are prone to agglomeration. This results in an extremely small probability of uniform distribution of the negative electrode active material in the negative electrode slurry, and non-uniform distribution of the negative electrode active material particles in the formed negative electrode active material layer affects the processing stability of the negative electrode sheet and causes the problem of uneven coating during a coating process of the negative electrode slurry. Moreover, a specific surface area of the negative electrode active material particles is too large, leading to an increase in interfaces between the negative electrode active material particles and the electrolyte, and intensifying side reactions. Especially in a superfast-charge high-kinetic-performance electrolyte system, side reactions are very intense, accelerating electrolyte consumption and generation of side reaction products, thereby deteriorating the cycling performance and high-temperature stability of the secondary battery. If the Dᵥ99 of the negative electrode active material is greater than 28 μm, the Dᵥ99 of the negative electrode active material is too large, the transmission path of lithium ions inside the negative electrode active material particles is too long, and the transmission tortuosity inside the negative electrode sheet is too large, leading to excessive concentration polarization inside the secondary battery, thereby increasing the internal resistance of the secondary battery and reducing the cycling kinetic performance of the secondary battery.

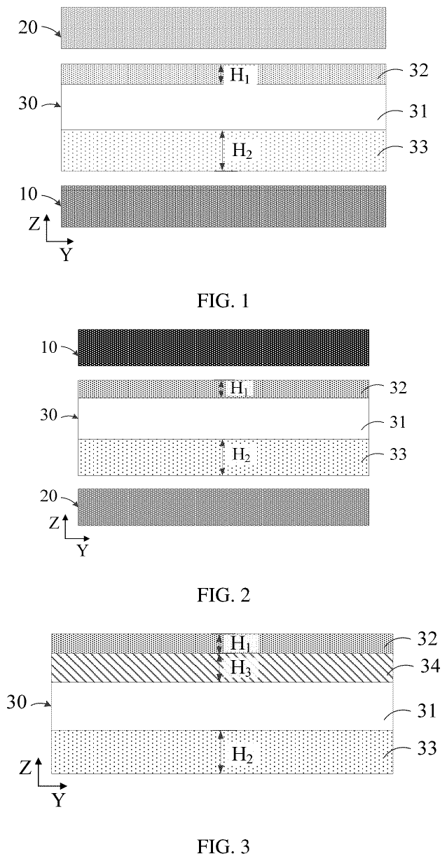

In the present application, for ease of understanding, a width direction of the separator in an unfolded state is defined as Y, and a thickness direction of the separator is defined as Z. It can be understood that length directions, width directions, and thickness directions of the positive electrode sheet and the negative electrode sheet in an unfolded state are the same as those of the separator. As shown in FIG. 1 and FIG. 2, the separator 30 includes a separator substrate 31, a first adhesive coating 32, and a second adhesive coating 33. The first adhesive coating 32 and the second adhesive coating 33 are respectively provided on two sides of the separator substrate 31, and the separator substrate 31 is located between the first adhesive coating 32 and the second adhesive coating 33. The first adhesive coating 32 may be close to a side of the positive electrode sheet 10 or close to a side of the negative electrode sheet 20. As shown in FIG. 1, the first adhesive coating 32 is provided on a side of the separator substrate 31 close to the negative electrode sheet 20, and the second adhesive coating 33 is provided on a side of the separator substrate 31 close to the positive electrode sheet 10. As shown in FIG. 2, the first adhesive coating 32 is provided on a side of the separator substrate 31 close to the positive electrode sheet 10, and the second adhesive coating 33 is provided on a side of the separator substrate 31 close to the negative electrode sheet 20.

For example, the average particle size of the first polymer binder is 0.3 μm, 0.5 μm, 1 μm, 1.5 μm, 2 μm, 2.5 μm, 3 μm, or any value within a range defined by any two of these values. If the average particle size of the first polymer binder is less than 0.3 μm, the average particle size of the first polymer binder is too small. During preparation of a first adhesive coating slurry, first polymer binder particles are prone to agglomeration. This results in an extremely small probability of uniform dispersion of the first polymer binder in the first adhesive coating slurry, and non-uniform distribution of the first polymer binder in the formed first adhesive coating affects adhesion strength of the first adhesive coating. If the average particle size of the first polymer binder is greater than 3 μm, the average particle size of the first polymer binder is too large, leading to excessive gaps between the first polymer binder particles and thus causing poor cycling performance. In addition, an excessive average particle size of the first polymer binder also causes thickness increase of the first adhesive coating, increasing the volume of the secondary battery and thus causing energy density loss of the secondary battery.

For example, the average particle size of the second polymer binder is 10 μm, 12 μm, 20 μm, 25 μm, 28 μm, 30 μm, 38 μm, or any value within a range defined by any two of these values. If the average particle size of the second polymer binder is less than 10 μm, the average particle size of the second polymer binder is too small, the gap between the separator and the positive electrode sheet or negative electrode sheet is too small, and a transmission channel of the electrolyte is too narrow, affecting the transmission of the electrolyte, thereby affecting the cycling performance and kinetic performance of the secondary battery. If the average particle size of the second polymer binder is greater than 38 μm, an excessive average particle size of the second polymer binder causes thickness increase of the second adhesive coating, increasing the volume of the secondary battery and thus causing energy density loss of the secondary battery.

For example, based on the mass of the electrolyte, the mass percentage of the linear carboxylate ester is 6%, 10%, 15%, 20%, 25%, 30%, 35%, 40%, 45%, 50%, 56%, or any value within a range defined by any two of these values. The linear carboxylate ester has the characteristics of having high conductivity and low viscosity, facilitating lithium ion transmission, and enabling an electrolyte to have high kinetic performance. If the mass percentage of the linear carboxylate ester is less than 6%, the percentage of the linear carboxylate ester in the electrolyte is too small to exert the characteristics of the linear carboxylate ester. If the mass percentage of the linear carboxylate ester is greater than 56%, the percentage of the linear carboxylate ester in the electrolyte is too large, and percentages of the lithium salt and additive in the electrolyte decrease accordingly. Therefore, insufficient lithium salt affects the charge-discharge performance of the secondary battery, and insufficient additive makes it difficult for the additive to exert its own effect, affecting the corresponding performance of the secondary battery and the additive.

Generally, in the present application, by adjusting the Dᵥ99 of the positive electrode active material and the negative electrode active material within the above ranges, lithium ions have a short transmission path inside the positive/negative electrode active material during the transmission process and a small transmission tortuosity inside the positive/negative electrode sheet, so as to reduce the concentration polarization of the secondary battery, thereby making the secondary battery have good cycling kinetic performance. In the present application, by adjusting the mass percentage of the linear carboxylate ester in the electrolyte within the above range, lithium ions have a high transmission speed in the electrolyte, so as to reduce the electrochemical polarization and concentration polarization of the secondary battery, reduce the impedance of the secondary battery, and reduce the charging temperature rise and shorten the charging time during fast charging of the secondary battery, thereby making the secondary battery have good cycling kinetic performance and fast-charging performance. That is, through the high kinetic performance design for the particle sizes of the positive and negative electrode active materials and the electrolyte composition, a high-rate chemical system of the secondary battery is ensured. However, the high kinetic performance design makes side reactions easy to take place between the positive and negative electrode active materials and the electrolyte. Especially, intense side reactions take place at high temperatures to generate a large amount of gas, resulting in poor high-temperature performance of the secondary battery. In the present application, a first adhesive coating and a second adhesive coating are respectively provided on two sides of the separator, and the average particle size of the first polymer binder in the first adhesive coating and the average particle size of the second polymer binder in the second adhesive coating are within the above ranges provided in the present application, so that a side of the separator where the first adhesive coating is provided has high adhesion strength, which can enhance the adhesion strength between the separator and the positive/negative electrode sheet, enhance an interface between the separator and the positive/negative electrode sheet, inhibit gas generation under high-temperature conditions, and reduce the probability of swelling of the secondary battery due to excessive gas generation, thereby improving the high-temperature stability. In a side of the separator where the second adhesive coating is provided, electrolyte flow channels may be generated to store the electrolyte, meeting the requirements of the secondary battery for high liquid retention capacity (such as 1.5 g/Ah to 2.4 g/Ah) and high transmission and infiltration performance of the electrolyte in a superfast charging state, thereby ensuring the rate performance and cycling performance of the secondary battery. In the present application, the separator, the Dᵥ99 of the positive electrode active material, the Dᵥ99 of the negative electrode active material, and the electrolyte are combined to play a good synergistic effect, thereby guaranteeing the high-temperature stability of the secondary battery while improving the cycling kinetic performance of the secondary battery.

In an embodiment of the present application, the linear carboxylate ester includes at least one of methyl formate, methyl acetate, ethyl formate, ethyl acetate, propyl acetate, ethyl propionate, methyl propionate, n-propyl propionate, isopropyl propionate, n-butyl propionate, isobutyl propionate, n-pentyl propionate, isopentyl propionate, ethyl butyrate, n-propyl butyrate, propyl isobutyrate, n-pentyl butyrate, n-pentyl isobutyrate, n-butyl butyrate, isobutyl isobutyrate, or n-pentyl valerate. The above types of linear carboxylate esters have high conductivity and low viscosity, facilitating lithium ion transmission. Use of the above types of linear carboxylate esters can make the secondary battery have good cycling kinetic performance and high-temperature stability.

In an embodiment of the present application, the Dᵥ99 of the positive electrode active material is 28 μm to 31 μm. For example, the Dᵥ99 of the positive electrode active material is 28 μm, 29 μm, 30 μm, 31 μm, or any value within a range defined by any two of these values. By adjusting the Dᵥ99 of the positive electrode active material within the above range, the range of the Dᵥ99 of the positive electrode active material is more appropriate, which helps to further improve the cycling kinetic performance and high-temperature stability of the secondary battery.

In an embodiment of the present application, the Dᵥ99 of the negative electrode active material is 24 μm to 26 μm. For example, the Dᵥ99 of the negative electrode active material is 24 μm, 25 μm, 26 μm, or any value within a range defined by any two of these values. By adjusting the Dᵥ99 of the negative electrode active material within the above range, the range of the Dᵥ99 of the negative electrode active material is more appropriate, which helps to further improve the cycling kinetic performance and high-temperature stability of the secondary battery.

In an embodiment of the present application, the Dᵥ99 of the positive electrode active material is 28 μm to 31 μm, and the Dᵥ99 of the negative electrode active material is 24 μm to 26 μm. For example, the Dᵥ99 of the positive electrode active material is 28 μm, 29 μm, 30 μm, 31 μm, or any value within a range defined by any two of these values; and the Dᵥ99 of the negative electrode active material is 24 μm, 25 μm, 26 μm, or any value within a range defined by any two of these values. By adjusting the Dᵥ99 of the positive electrode active material and the negative electrode active material within the above ranges, the ranges of the Dᵥ99 of the positive electrode active material and the negative electrode active material are more appropriate, which helps to further improve the cycling kinetic performance and high-temperature stability of the secondary battery.

In the present application, Dᵥ99 represents a particle size at which the cumulative volume reaches 99% from the small particle size side in volume-based particle size distribution. The above “particles” in the present application may be particles of the positive electrode active material or particles of the negative electrode active material. The present application has no particular limitation on an adjustment method of the Dᵥ99 of the positive electrode active material and the negative electrode active material, as long as the purposes of the present application can be achieved. For example, the adjustment can be implemented by directly purchasing positive electrode active materials and negative electrode active materials with Dᵥ99 within the ranges provided in the present application, or by crushing, grinding, or ball milling.

In an embodiment of the present application, the average particle size of the first polymer binder is 0.6 μm to 1.6 μm. In another embodiment of the present application, the average particle size of the second polymer binder is 20 μm to 30 μm. In still another embodiment of the present application, the average particle size of the first polymer binder is 0.6 μm to 1.6 μm, and the average particle size of the second polymer binder is 20 μm to 30 μm. For example, the average particle size of the first polymer binder is 0.6 μm, 0.8 μm, 1.0 μm, 1.6 μm, or any value within a range defined by any two of these values. For example, the average particle size of the second polymer binder is 20 μm, 22 μm, 25 μm, 27 μm, 30 μm, or any value within a range defined by any two of these values. Adjusting the average particle size of the first polymer binder within the above range facilitates uniform distribution of the first polymer binder in the first adhesive coating, and appropriate gaps between the first polymer binder particles make the high binder coating have higher adhesion strength. In addition, the adjustment also helps to adjust the thickness of the first adhesive coating within an appropriate range, thereby making the secondary battery have high energy density while guaranteeing both the cycling kinetic performance and high-temperature stability. By adjusting the average particle size of the second polymer binder within the above range, an appropriate gap is between the separator and the positive electrode sheet and/or negative electrode sheet, which facilitates the transmission of the electrolyte, and also helps to adjust the thickness of the second adhesive coating within an appropriate range, thereby making the secondary battery have high energy density while guaranteeing both the cycling kinetic performance and high-temperature stability.

In an embodiment of the present application, the Dᵥ50 of the positive electrode active material is 10 μm to 15 μm, and the Dᵥ50 of the negative electrode active material is 7 μm to 12 μm. For example, the Dᵥ50 of the positive electrode active material is 10 μm, 11 μm, 12 μm, 13 μm, 14 μm, 15 μm, or any value within a range defined by any two of these values. The Dᵥ50 of the negative electrode active material is 7 μm, 8 μm, 9 μm, 10 μm, 11 μm, 12 μm, or any value within a range defined by any two of these values. By adjusting the Dᵥ50 of the positive electrode active material and the negative electrode active material within the above ranges, the risk of agglomeration of the positive electrode active material in the positive electrode slurry is low, and the risk of agglomeration of the negative electrode active material in the negative electrode slurry is low, so that the thicknesses of the positive electrode active material layer and the negative electrode active material layer can be adjusted within appropriate ranges while the positive electrode active material and the negative electrode active material play their effects, so as to reduce the risk of energy density loss caused by thickness increase, thereby helping to make the secondary battery have high energy density while having good cycling kinetic performance and high-temperature stability.

In an embodiment of the present application, the first adhesive coating is provided on a side of the separator substrate close to the negative electrode sheet, and the second adhesive coating is provided on a side of the separator substrate close to the positive electrode sheet. As shown in FIG. 1, the first adhesive coating 32 is provided on a side of the separator substrate 31 close to the negative electrode sheet 20, and the second adhesive coating 33 is provided on a side of the separator substrate 31 close to the positive electrode sheet 10. By setting the positional relationships between the first and adhesive coatings in the separator and the negative and positive electrode sheets, the secondary battery has further improved cycling kinetic performance while having good high-temperature stability. In addition, for most secondary batteries, the main requirement is fast charge for energy replenishment, but there is no demand for fast discharge, that is, a charging rate is much greater than a discharging rate. The charging process of the secondary battery mainly involves the intercalation of lithium ions into a negative electrode. Therefore, the provision of the first adhesive coating with smaller particles on the separator on a side close to the negative electrode sheet can shorten the lithium ion transmission path during the charging process and achieve a higher charging speed.

In an embodiment of the present application, as shown in FIG. 1 and FIG. 2, a thickness H₁ of the first adhesive coating 32 is 0.2 μm to 4 μm. For example, the thickness H₁ of the first adhesive coating is 0.2 μm, 0.5 μm, 1 μm, 1.5 μm, 2 μm, 2.5 μm, 3 μm, 3.5 μm, 4 μm, or any value within a range defined by any two of these values. When the particle size of the first polymer binder in the first adhesive coating is small, the adhesion strength of the first adhesive coating is high. By adjusting the thickness of the first adhesive coating within the above range, the first adhesive coating has an appropriate thickness, which can reduce the risk of energy density loss caused by volume increase of the secondary battery due to excessive thickness while ensuring the adhesion strength of the first adhesive coating, thereby increasing the energy density of the secondary battery and shortening the transmission path of lithium ions in an active material layer corresponding to the first adhesive coating. Thus, the secondary battery can have good energy density while guaranteeing both the cycling kinetic performance and high-temperature stability.

In an embodiment of the present application, as shown in FIG. 1 and FIG. 2, a thickness H₂ of the second adhesive coating 33 is 5 μm to 20 μm. For example, the thickness H₂ of the second adhesive coating is 5 μm, 6 μm, 8 μm, 10 μm, 12 μm, 14 μm, 16 μm, 18 μm, 20 μm, or any value within a range defined by any two of these values. When the particle size of the second polymer binder in the second adhesive coating is large, electrolyte flow channels can be formed. By adjusting the thickness of the second adhesive coating within the above range, the second adhesive coating has an appropriate thickness, which can reduce the risk of energy density loss caused by volume increase of the secondary battery due to excessive thickness under a condition that the electrolyte has good flow and infiltration in the electrode sheet and the separator. Thus, the secondary battery can have good energy density while guaranteeing both the cycling kinetic performance and high-temperature stability.

In an embodiment of the present application, a single-side coating weight of the first adhesive coating is 0.0001 mg/mm² to 0.001 mg/mm². For example, the single-side coating weight of the first adhesive coating is 0.0001 mg/mm², 0.0002 mg/mm², 0.0003 mg/mm², 0.0004 mg/mm², 0.0005 mg/mm², 0.0006 mg/mm², 0.0007 mg/mm², 0.0008 mg/mm², 0.0009 mg/mm², 0.001 mg/mm², or any value within a range defined by any two of these values. Adjusting the single-side coating weight of the first adhesive coating within the above range can fully exert the high adhesion characteristic of the first adhesive coating, so that the electrode sheet and the separator are better adhered, thereby ensuring the high-temperature stability and mechanical reliability of the secondary battery. In addition, the adjustment can also reduce the risk of energy density loss caused by volume increase of the secondary battery due to excessive single-side coating weight. Thus, the secondary battery can have good energy density while guaranteeing both the cycling kinetic performance and high-temperature stability.

In an embodiment of the present application, a single-side coating weight of the second adhesive coating is 0.0004 mg/mm² to 0.002 mg/mm². For example, the single-side coating weight of the second adhesive coating is 0.0004 mg/mm², 0.0008 mg/mm², 0.0012 mg/mm², 0.0016 mg/mm², 0.002 mg/mm², or any value within a range defined by any two of these values. Adjusting the single-side coating weight of the second adhesive coating within the above range can fully realize formation of the electrolyte flow channels between the electrode sheet and the separator, thereby improving the kinetic performance and cycling characteristics of the secondary battery.

In an embodiment of the present application, a coverage rate Cr₁ of the first polymer binder in the first adhesive coating per unit area is 40% to 60%. For example, the coverage rate of the first polymer binder in the first adhesive coating per unit area is 40%, 42%, 44%, 46%, 48%, 50%, 52%, 54%, 56%, 58%, 60%, or any value within a range defined by any two of these values. Adjusting the coverage rate of the first polymer binder in the first adhesive coating per unit area within the above range can make the secondary battery have low production costs while guaranteeing both the cycling kinetic performance and high-temperature stability, fully exert the high adhesion characteristic of the first adhesive coating, and achieve a high transmission speed of lithium ions while facilitating the adhesion between the separator and the electrode sheet, thereby further helping to make the secondary battery have good kinetic performance.

In an embodiment of the present application, the first polymer binder is a core-shell structure. The first polymer binder includes a first shell and a first core, where a polymerization monomer of the first shell includes at least one of methyl acrylate, ethyl acrylate, butyl acrylate, methyl methacrylate, ethyl methacrylate, butyl methacrylate, ethylene, ethyl chloromethyl acrylate, chlorostyrene, fluorostyrene, methylstyrene, acrylonitrile, or methacrylonitrile, and a polymerization monomer of the first core includes at least one of ethyl acrylate, butyl acrylate, ethyl methacrylate, styrene, chlorostyrene, fluorostyrene, methylstyrene, acrylic acid, methacrylic acid, or maleic acid. Applying the above types of first polymer binders to the first adhesive coating can make the first adhesive coating have high adhesion strength.

In an embodiment of the present application, the first polymer binder is a non-core-shell structure, where a polymerization monomer of the first polymer binder includes at least one of acrylic acid, methyl acrylate, butyl acrylate, butadiene, styrene, acrylonitrile, ethylene, fluorostyrene, chlorostyrene, or propylene. Applying the above types of first polymer binders to the first adhesive coating can make the first adhesive coating have high adhesion strength.

In an embodiment of the present application, the first adhesive coating includes a first polymer binder, a thickener, an auxiliary binder, and a wetting agent. Applying the thickener to the first adhesive coating can improve the stability of the first adhesive coating slurry and prevent sedimentation of each component in the first adhesive coating slurry. By applying the auxiliary binder to the first adhesive coating, the first polymer binder can be adhered to the separator substrate and a ceramic coating during a coating process of the first adhesive coating slurry. Applying the wetting agent to the first adhesive coating can reduce the surface energy of the first adhesive coating slurry and prevent omission of coating during the coating process of the first adhesive coating slurry. The present application has no particular limitation on percentages of the first polymer binder, thickener, auxiliary binder, and wetting agent in the first adhesive coating, as long as the purposes of the present application can be achieved. For example, based on a mass of the first adhesive coating, a mass percentage of the first polymer binder is 85% to 95%, a mass percentage of the thickener is 0.5% to 2%, a mass percentage of the auxiliary binder is 0% to 15%, and a mass percentage of the wetting agent is 4% to 10%.

In an embodiment of the present application, a coverage rate Cr₂ of the second polymer binder in the second adhesive coating per unit area is 40% to 60%. For example, the coverage rate of the second polymer binder in the second adhesive coating per unit area is 40%, 42%, 44%, 46%, 48%, 50%, 52%, 54%, 56%, 58%, 60%, or any value within a range defined by any two of these values. By adjusting the coverage rate of the second polymer binder in the second adhesive coating per unit area within the above range, the second polymer binder enables a large gap between the second adhesive coating and the positive electrode sheet or negative electrode sheet, so that the secondary battery can have wider electrolyte transmission channels during a cycling process, which can fully realize formation of electrolyte flow channels between the electrode sheet and the separator. Under a condition that the electrolyte has good flow and infiltration in the electrode sheet and the separator, the second adhesive coating has an appropriate thickness, thereby reducing the risk of energy density loss caused by volume increase of a fast-charge secondary battery due to excessive thickness. Thus, the secondary battery can have higher energy density while guaranteeing both the cycling kinetic performance and high-temperature stability.

In an embodiment of the present application, the second polymer binder is a core-shell structure. The second polymer binder includes a second shell and a second core, where a polymerization monomer of the second shell includes at least one of vinylidene chloride, vinylidene fluoride, hexafluoropropylene, styrene, butadiene, acrylonitrile, acrylic acid, methyl acrylate, or butyl acrylate, and a polymerization monomer of the second core includes at least one of ethyl methacrylate, methyl acrylate, ethyl acrylate, butyl acrylate, methyl methacrylate, butyl methacrylate, or ethyl chloromethyl acrylate. Use of the above types of second polymer binders enables a large gap between the second adhesive coating and the positive/negative electrode sheet.

In an embodiment of the present application, the second polymer binder is a non-core-shell structure, where a polymerization monomer of the second polymer binder includes at least one of vinylidene chloride, vinylidene fluoride, hexafluoropropylene, ethylene, propylene, vinyl chloride, chloropropene, acrylic acid, methyl acrylate, butyl acrylate, styrene, butadiene, or acrylonitrile. Use of the above types of second polymer binders enables a large gap between the second adhesive coating and the positive/negative electrode sheet.

In an embodiment of the present application, the second adhesive coating includes a second polymer binder and an auxiliary binder. By applying the auxiliary binder to the second adhesive coating, the second polymer binder can be adhered to the separator substrate and a ceramic coating during a coating process of the second adhesive coating slurry. The present application has no particular limitation on percentages of the second polymer binder and the auxiliary binder in the second adhesive coating, as long as the purposes of the present application can be achieved. For example, based on a mass of the second adhesive coating, a mass percentage of the second polymer binder is 85% to 95%, and a mass percentage of the auxiliary binder is 5% to 15%.

The present application has no particular limitation on the types of the thickener, auxiliary binder, and wetting agent, as long as the purposes of the present application can be achieved. For example, the thickener includes but is not limited to sodium carboxymethyl cellulose. For example, the auxiliary binder includes but is not limited to a homopolymer or copolymer formed by polymerization of at least one of the following monomers: ethyl acrylate, butyl acrylate, ethyl methacrylate, acrylic acid, methacrylic acid, maleic anhydride, dicarboxylic anhydride, acrylonitrile, butadiene, or a monovinyl compound. The present application has no particular limitation on the type of the above monovinyl compound, as long as the purposes of the present application can be achieved. For example, the monovinyl compound includes but is not limited to at least one of styrene, chlorostyrene, fluorostyrene, or methylstyrene. For example, the wetting agent includes but is not limited to at least one of sodium carboxymethyl cellulose, dimethylsiloxane, polyethylene oxide dimethylsiloxane, polyethylene oxide, oxyethylene alkylphenol ether, polyoxyethylene fatty alcohol ether, oxyethylene alkylphenol ether, polyoxyethylene fatty alcohol ether, polyoxyethylene polyoxypropylene block copolymer, or sodium dioctyl sulfosuccinate.

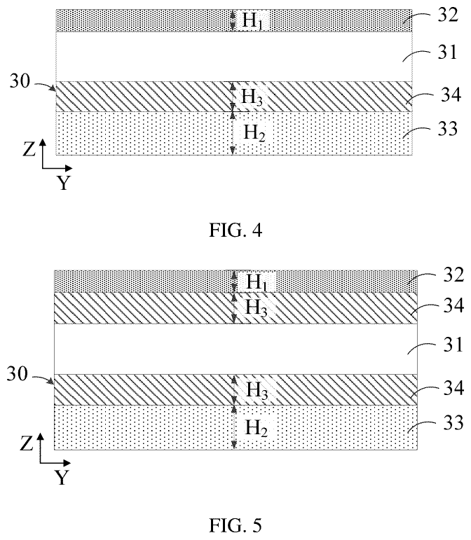

In an embodiment of the present application, the separator further includes a ceramic coating. The ceramic coating is provided between the separator substrate and the first adhesive coating, and/or the ceramic coating is provided between the separator substrate and the second adhesive coating. In some embodiments, as shown in FIG. 3, the separator 30 includes a separator substrate 31, a first adhesive coating 32, a second adhesive coating 33, and a ceramic coating 34, where the first adhesive coating 32 and the second adhesive coating 33 are respectively provided on two sides of the separator substrate 31, the ceramic coating 34 is provided between the separator substrate 31 and the first adhesive coating 32, and the second adhesive coating 33 is adjacent to a surface of the separator substrate 31 away from the ceramic coating 34. In some other embodiments, as shown in FIG. 4, the separator 30 includes a separator substrate 31, a first adhesive coating 32, a second adhesive coating 33, and a ceramic coating 34, where the first adhesive coating 32 and the second adhesive coating 33 are respectively provided on two sides of the separator substrate 31, the ceramic coating 34 is provided between the separator substrate 31 and the second adhesive coating 33, and the first adhesive coating 32 is adjacent to the surface of the separator substrate 31 away from the ceramic coating 34. In still some other embodiments, as shown in FIG. 5, the separator 30 includes a separator substrate 31, a first adhesive coating 32, a second adhesive coating 33, and two ceramic coatings 34, where the first adhesive coating 32 and the second adhesive coating 33 are respectively provided on two sides of the separator substrate 31, one ceramic coating 34 is provided between the separator substrate 31 and the first adhesive coating 32, and the other ceramic coating 34 is provided between the separator substrate 31 and the second adhesive coating 33. It should be noted that the above two ceramic coatings may be the same or different. The ceramic coating has good hardness and heat resistance. By providing the ceramic coating in the separator, the ceramic coating can prevent the separator from shrinking at high temperatures, and can improve the hardness and heat resistance of the secondary battery, thereby making the secondary battery have good thermal safety performance and mechanical reliability while having good cycling kinetic performance and high-temperature stability. In the present application, it is preferred that the second adhesive coating 33 faces the positive electrode sheet 10, and the ceramic coating 34 is provided between the separator substrate 31 and the second adhesive coating 33 to store the electrolyte. Alternatively, additional electrolyte flow channels may be provided outside electrolyte channels formed by the second adhesive coating 33, which can reduce the thickness of the second adhesive coating 33, increase the energy density, protect the separator substrate 31 from being oxidized due to a high voltage of the positive electrode, and reduce a coating thickness of the second adhesive coating 33.

In an embodiment of the present application, the ceramic coating includes ceramic particles and a ceramic coating binder. The present application has no particular limitation on the types of the ceramic particles and ceramic coating binder, as long as the purposes of the present application can be achieved. For example, the ceramic particles include but are not limited to at least one of alumina, boehmite, titania, silica, zirconia, stannic oxide, magnesium hydroxide, magnesia, zinc oxide, barium sulfate, boron nitride, aluminum nitride, or silicon nitride. The ceramic coating binder includes but is not limited to at least one of polyvinylidene fluoride, polyacrylic acid, polymethyl methacrylate, polybutyl acrylate, or polyacrylonitrile. The present application has no particular limitation on percentages of the ceramic particles and the ceramic coating binder in the ceramic coating, as long as the purposes of the present application can be achieved. For example, based on a mass of the ceramic coating, a mass percentage of the ceramic particles is 5% to 95%, and a mass percentage of the ceramic coating binder is 5% to 95%. The present application has no particular limitation on an average particle size of the ceramic particles, as long as the purposes of the present application can be achieved. For example, the average particle size of the ceramic particles is 1 μm to 3 μm. The present application has no particular limitation on a thickness of the ceramic coating. For example, the thickness of the ceramic coating may be 0.5 μm to 6 μm.

In the present application, Dᵥ50 represents a particle size at which the cumulative volume reaches 50% from the small particle size side in volume-based particle size distribution. The above “particles” in the present application may be the positive electrode active material or the negative electrode active material. The present application has no particular limitation on an adjustment method of the Dᵥ50 of the positive electrode active material and the Dᵥ50 of the negative electrode active material, as long as the purposes of the present application can be achieved. For example, the adjustment can be implemented by directly purchasing positive electrode active materials and negative electrode active materials with Dᵥ50 within the ranges provided in the present application, or by crushing, grinding, or ball milling.

In the present application, the average particle size can be understood as an equivalent diameter, and the equivalent diameter generally refers to a diameter of a sphere having the same volume as an object with an irregular shape. In the present application, a cross section of an electrode sheet is obtained, an area of a to-be-measured object particle on the cross section is measured, and then a diameter of a circle having the same area is used as an equivalent diameter of the to-be-measured object particle. The present application has no particular limitation on an adjustment method of the average particle size of the first polymer binder, the average particle size of the second polymer binder, and the average particle size of the ceramic particles, as long as the purposes of the present application can be achieved. For example, the adjustment can be implemented by directly purchasing first polymer binders, second polymer binders, and ceramic particles with average particle sizes within the ranges provided in the present application, or by crushing, grinding, or ball milling.

The present application has no particular limitation on the separator substrate, as long as the purposes of the present application can be achieved. For example, a structure of the separator substrate includes a single-layer structure or a multi-layer composite structure, where the multi-layer composite structure may be a two-layer composite structure, a three-layer composite structure, or a four-layer composite structure. A type of the separator substrate includes at least one of polyethylene (PE), polypropylene (PP), or polyethylene terephthalate (PET). A thickness of the separator substrate may be 3 μm to 20 μm.

In an embodiment of the present application, based on the mass of the electrolyte, the mass percentage of the linear carboxylate ester is 18% to 40%. For example, based on the mass of the electrolyte, the mass percentage of the linear carboxylate ester is 18%, 20%, 25%, 30%, 35%, 40%, or any value within a range defined by any two of these values. By adjusting the mass percentage of the linear carboxylate ester within the above range, lithium ions have a higher transmission speed in the electrolyte, thereby further improving the cycling kinetic performance of the secondary battery while the secondary battery has good high-temperature stability.

In an embodiment of the present application, the organic solvent further includes at least one of ethylene carbonate, propylene carbonate, dimethyl carbonate, diethyl carbonate, methyl ethyl carbonate, γ-butyrolactone, or tetrahydrofuran. The above types of organic solvents have the characteristics of good stability at high temperatures and excellent lithium ion transmission ability at low temperatures. Adding the above types of organic solvents to the electrolyte can further improve the high-temperature stability, cycling kinetic performance, and capacity retention rate after storage of the secondary battery.

In an embodiment of the present application, based on the mass of the electrolyte, a mass percentage of the organic solvent is 60% to 90%. For example, based on the mass of the electrolyte, the mass percentage of the organic solvent is 60%, 65%, 70%, 75%, 80%, 85%, 90%, or any value within a range defined by any two of these values. Adjusting the mass percentage of the organic solvent within the above range helps to increase the solubilities of the additive and lithium salt, which makes the electrolyte have low viscosity and high conductivity, facilitating migration of lithium ions in the electrolyte, thereby making the secondary battery have good cycling kinetic performance and high-temperature stability.

In an embodiment of the present application, based on the mass of the electrolyte, a mass percentage of the lithium salt is 8% to 20%. For example, the mass percentage of the lithium salt is 8%, 10%, 12%, 14%, 16%, 18%, 20%, or any value within a range defined by any two of these values. The present application has no particular limitation on a type of the lithium salt, as long as the purposes of the present application can be achieved. For example, the lithium salt includes but is not limited to at least one of lithium hexafluorophosphate, lithium difluorophosphate, lithium tetrafluoroborate, lithium hexafluoroarsenate, lithium perchlorate, lithium bis(fluorosulfonyl)imide, lithium bis(trifluoromethanesulfonyl)imide, lithium bis(oxalato)borate, or lithium difluoro(oxalato)borate.

In an embodiment of the present application, based on the mass of the electrolyte, a mass percentage of the additive is 2% to 20%. For example, the mass percentage of the additive is 2%, 4%, 6%, 8%, 10%, 12%, 14%, 16%, 18%, 20%, or any value within a range defined by any two of these values. The present application has no particular limitation on a type of the additive, as long as the purposes of the present application can be achieved. For example, the additive includes but is not limited to at least one of succinonitrile, glutaronitrile, pimelonitrile, 1,2-bis(2-cyanoethoxy)ethane, 1,2-bis(2-cyanoethoxy)propane, or 1,2-(3-cyanopropoxy)ethane.

In an embodiment of the present application, the negative electrode active material includes at least one of a carbon-based material, a silicon-based material, or a tin-based material. The carbon-based material includes at least one of natural graphite, artificial graphite, soft carbon, hard carbon, or mesocarbon microbeads. The silicon-based material includes at least one of elemental silicon, a silicon-carbon material, or a silicon-oxygen material. The tin-based material includes at least one of elemental tin, tin alloy, or tin oxide. The above types of negative electrode active materials have high surface activity. Applying them to the secondary battery can increase active sites for intercalation and deintercalation of lithium ions, and reduce the electrochemical polarization of the secondary battery, thereby reducing the impedance of the secondary battery, and making the secondary battery have good cycling kinetic performance while having high-temperature stability.

In an embodiment of the present application, a peak intensity ratio I_{d}/I_{g} of peak d to peak g in a Raman test of the carbon-based material satisfies: 0.2≤I_{d}/I_{g}≤1.0. For example, I_{d}/I_{g} is 0.2, 0.3, 0.4, 0.5, 0.6, 0.7, 0.8, 0.9, 1.0, or any value within a range defined by any two of these values. It indicates that a surface of the carbon-based material contains amorphous carbon. The amorphous carbon contained in the surface of the carbon-based material can improve the electrochemical activity of the carbon-based material. During a cycling process of the secondary battery, the intercalation of lithium ions is smoother, which helps to reduce the electrochemical polarization of the secondary battery, thereby reducing the internal impedance of the secondary battery and improving the cycling kinetic performance of the secondary battery. Applying a carbon-based material with the above I_{d}/I_{g} value to the secondary battery helps to further improve the cycling kinetic performance of the secondary battery while the secondary battery has good high-temperature stability.

In the present application, the peak d is a peak with a shift range of 1300 cm⁻¹ to 1400 cm⁻¹ in a Raman spectrum of carbon-based material particles, and the peak g is a peak with a shift range of 1530 cm⁻¹ to 1630 cm⁻¹ in the Raman spectrum of the carbon-based material particles.

The present application has no particular limitation on an adjustment method of the I_{d}/I_{g} value, as long as the purposes of the present application can be achieved. For example, a commercially available carbon-based material having a surface coated with different contents of amorphous carbon can be selected, and a carbon-based material with the required I_{d}/I_{g} is selected by determining the I_{d}/I_{g} of the carbon-based material in combination with a test method of the “Raman (Raman) test” in the present application.

The present application has no particular limitation on a preparation method of the carbon-based material, as long as the purposes of the present application can be achieved. For example, the preparation method of the carbon-based material may include but is not limited to: mixing a carbon-based material and amorphous carbon uniformly, heating the resulting mixture to 500° C. to 1500° C., and then maintaining the temperature for 10 h to 20 h to obtain a carbon-based material having a surface coated with amorphous carbon.

In an embodiment of the present application, the positive electrode active material includes at least one of lithium nickel cobalt manganese oxide, lithium nickel cobalt aluminum oxide, lithium iron phosphate, a lithium-rich manganese-based material, lithium cobalt oxide, lithium manganese oxide, lithium manganese iron phosphate, or lithium titanate. A chemical formula of the above “lithium-rich manganese-based material” is LiMnO·LiMO, where M may include Ni, Co, or Mn. The above types of positive electrode active materials have high surface activity. Applying them to the secondary battery can increase active sites for intercalation and deintercalation of lithium ions, and reduce the electrochemical polarization of the secondary battery, thereby reducing the impedance of the secondary battery, and making the secondary battery have good cycling kinetic performance while having high-temperature stability.

In an embodiment of the present application, the positive electrode active material further includes a non-metal element, and the non-metal element includes at least one of fluorine, phosphorus, boron, chlorine, silicon, or sulfur. The present application has no particular limitation on percentage of the non-metal element in the positive electrode active material, as long as the purposes of the present application can be achieved. For example, based on a mass of the positive electrode active material, a mass percentage of the non-metal element is 0.1% to 10%. For example, the mass percentage of the non-metal element is 0.1%, 1%, 2%, 3%, 4%, 5%, 6%, 7%, 8%, 9%, 10%, or any value within a range defined by any two of these values. When the positive electrode active material includes the above types of non-metal elements, the stability of the positive electrode active material can be further improved.

The positive electrode sheet of the present application includes a positive electrode current collector and a positive electrode active material layer provided on at least one surface of the positive electrode current collector. In some embodiments, the positive electrode active material layer is provided on one surface of the positive electrode current collector, and in some other embodiments, the positive electrode active material layer is provided on two surfaces of the positive electrode current collector, where the above “surface” may be a partial surface or an entire surface of the positive electrode current collector. The present application has no particular limitation on a type of the positive electrode current collector, as long as the purposes of the present application can be achieved. For example, the positive electrode current collector may include but is not limited to aluminum foil or aluminum alloy foil. The positive electrode active material layer of the present application includes the positive electrode active material described in the foregoing embodiments. In the present application, thicknesses of the positive electrode current collector and the positive electrode active material layer are not particularly limited, as long as the purposes of the present application can be achieved. For example, the thickness of the positive electrode current collector is 5 μm to 20 μm. Further, the thickness of the positive electrode current collector may be 6 μm to 18 μm. The thickness of the positive electrode active material layer is 30 μm to 120 μm.

Optionally, the positive electrode active material layer may further include a positive electrode conductive agent and a positive electrode binder. The present application has no particular limitation on types of the positive electrode conductive agent and the positive electrode binder in the positive electrode active material layer, as long as the purposes of the present application can be achieved. The present application has no particular limitation on a mass ratio of the positive electrode active material, positive electrode conductive agent, and positive electrode binder in the positive electrode active material layer. Those skilled in the art can select according to actual needs, as long as the purposes of the present application can be achieved. For example, the mass ratio of the positive electrode active material, positive electrode conductive agent, and positive electrode binder in the positive electrode active material layer is (95-98):(0.5-3.5):(1.5-3.4).

The negative electrode sheet of the present application includes a negative electrode current collector and a negative electrode active material layer provided on at least one surface of the negative electrode current collector. In some embodiments, the negative electrode active material layer is provided on one surface of the negative electrode current collector, and in some other embodiments, the negative electrode active material layer is provided on two surfaces of the negative electrode current collector, where the above “surface” may be a partial surface or an entire surface of the negative electrode current collector. The present application has no particular limitation on a type of the negative electrode current collector, as long as the purposes of the present application can be achieved. For example, the negative electrode current collector includes but is not limited to copper foil, copper alloy foil, nickel foil, titanium foil, foamed nickel, or foamed copper. The negative electrode active material layer of the present application includes the negative electrode active material described in the foregoing embodiments. In the present application, thicknesses of the negative electrode current collector and the negative electrode active material layer are not particularly limited, as long as the purposes of the present application can be achieved. For example, the thickness of the negative electrode current collector is 6 μm to 10 μm, and the thickness of the negative electrode active material layer is 30 μm to 130 μm.

Optionally, the negative electrode active material layer may further include at least one of a negative electrode conductive agent, a dispersant, and a negative electrode binder. The present application has no particular limitation on types of the negative electrode conductive agent, dispersant, and negative electrode binder in the negative electrode active material layer, as long as the purposes of the present application can be achieved. The present application has no particular limitation on a mass ratio of the negative electrode active material, negative electrode conductive agent, dispersant, and negative electrode binder in the negative electrode active material layer, as long as the purposes of the present application can be achieved. For example, the mass ratio of the negative electrode active material, negative electrode conductive agent, dispersant, and negative electrode binder in the negative electrode active material layer is (96-98):(0-2):(0-1.5):(1.0-1.9).

In an embodiment of the present application, the secondary battery further includes a case, where the electrode assembly and the electrolyte are accommodated in the case. The present application has no particular limitation on the case, which may be a case well known in the art, as long as the purposes of the present application can be achieved. For example, the case includes but is not limited to an aluminum-plastic film or a steel case.

The present application has no particular limitation on a type of the secondary battery, which may include any apparatus in which an electrochemical reaction takes place. For example, the secondary battery may include but is not limited to: a lithium metal secondary battery, a lithium-ion secondary battery (lithium-ion battery), a sodium-ion secondary battery (sodium-ion battery), a lithium polymer secondary battery, or a lithium-ion polymer secondary battery.

The secondary battery of the present application can be used under superfast charging conditions. Specifically, it can be used under conditions of 5 C to 15 C. For example, a charging rate of the secondary battery may be 5 C, 6 C, 7 C, 8 C, 9 C, 10 C, 11 C, 12 C, 13 C, 14 C, 15 C, or any rate within a range defined by any two of these rates.

The present application has no particular limitation on a preparation method of the separator, as long as the purposes of the present application can be achieved.

For example, in an embodiment, the preparation method of the separator includes but is not limited to the following steps: (1) mixing a first polymer binder, a thickener, an auxiliary binder, and a wetting agent uniformly to obtain a first adhesive coating slurry; (2) mixing a second polymer binder and an auxiliary binder uniformly to obtain a second adhesive coating slurry; and (3) coating one surface of a separator substrate with the first adhesive coating slurry, followed by drying to form a first adhesive coating on one surface of the separator substrate; and coating the other surface of the separator substrate with the second adhesive coating slurry, followed by drying to form a second adhesive coating on the other surface of the separator substrate, to obtain a separator.

For example, in another embodiment, the preparation method of the separator includes but is not limited to the following steps: (1) mixing a first polymer binder, a thickener, an auxiliary binder, and a wetting agent uniformly to obtain a first adhesive coating slurry; (2) mixing a second polymer binder and an auxiliary binder uniformly to obtain a second adhesive coating slurry; (3) mixing ceramic particles and a ceramic coating binder uniformly to obtain a ceramic coating slurry; and (4) coating one surface of the separator substrate with the ceramic coating slurry, followed by drying to form a ceramic coating on one surface of the separator substrate; coating a surface of the ceramic coating with the first adhesive coating slurry, followed by drying to form a first adhesive coating on a surface of the ceramic coating away from the separator substrate; and coating the other surface of the separator substrate with the second adhesive coating slurry, followed by drying to form a second adhesive coating on the other surface of the separator substrate, to obtain a separator.

For example, in still another embodiment, the preparation method of the separator includes but is not limited to the following steps: (1) mixing a first polymer binder, a thickener, an auxiliary binder, and a wetting agent uniformly to obtain a first adhesive coating slurry; (2) mixing a second polymer binder and an auxiliary binder uniformly to obtain a second adhesive coating slurry; (3) mixing ceramic particles and a ceramic coating binder uniformly to obtain a ceramic coating slurry; and (4) coating one surface of the separator substrate with the ceramic coating slurry, followed by drying to form a ceramic coating on one surface of the separator substrate; coating a surface of the ceramic coating with the second adhesive coating slurry, followed by drying to form a second adhesive coating on a surface of the ceramic coating away from the separator substrate; and coating the other surface of the separator substrate with the first adhesive coating slurry, followed by drying to form a first adhesive coating on the other surface of the separator substrate, to obtain a separator.

For example, in yet another embodiment, the preparation method of the separator includes but is not limited to the following steps: (1) mixing a first polymer binder, a thickener, an auxiliary binder, and a wetting agent uniformly to obtain a first adhesive coating slurry; (2) mixing a second polymer binder and an auxiliary binder uniformly to obtain a second adhesive coating slurry; (3) mixing ceramic particles and a ceramic coating binder uniformly to obtain a ceramic coating slurry; and (4) coating one surface of the separator substrate with the ceramic coating slurry, followed by drying to form a ceramic coating on one surface of the separator substrate; coating the other surface of the separator substrate with the ceramic coating slurry, followed by drying to form a ceramic coating on the other surface of the separator substrate; coating a surface of the first ceramic coating away from the separator substrate with the second adhesive coating slurry, followed by drying to form a second adhesive coating on the surface of the first ceramic coating away from the separator substrate; and coating a surface of the second ceramic coating away from the separator substrate with the first adhesive coating slurry, followed by drying to form a first adhesive coating on the surface of the second ceramic coating away from the separator substrate, to obtain a separator.

The present application has no particular limitation on a solid content of the above first adhesive coating slurry, as long as the purposes of the present application can be achieved. For example, the solid content of the first adhesive coating slurry is 60 wt % to 80 wt %. The present application has no particular limitation on the solid content of the above second adhesive coating slurry, as long as the purposes of the present application can be achieved. For example, the solid content of the second adhesive coating slurry is 60 wt % to 80 wt %. The present application has no particular limitation on a solid content of the above ceramic coating slurry, as long as the purposes of the present application can be achieved. For example, the solid content of the ceramic coating slurry is 30 wt % to 40 wt %. The present application has no particular limitation on temperature and time for the above drying. Those skilled in the art can select and adjust according to actual needs, as long as the purposes of the present application can be achieved.

The present application has no particular limitation on a preparation method of the secondary battery, and a preparation method well known in the art can be selected, as long as the purposes of the present application can be achieved. For example, the preparation method of the secondary battery includes but is not limited to the following steps: stacking a separator, a positive electrode sheet, a separator, and a negative electrode sheet in sequence, performing operations such as winding and folding as needed to obtain a wound electrode assembly, placing the electrode assembly into a case, and injecting an electrolyte into the case, followed by sealing to obtain a secondary battery; or stacking a separator, a positive electrode sheet, a separator, and a negative electrode sheet in sequence, fixing four corners of the entire stacked structure to obtain a stacked electrode assembly, placing the electrode assembly into a case, and injecting an electrolyte into the case, followed by sealing to obtain a secondary battery.

According to a second aspect, the present application provides an electric apparatus, which includes the secondary battery described in any one of the foregoing embodiments. Therefore, the electric apparatus has good use performance.

The electric apparatus of the present application is not particularly limited, and may be any electric apparatus known in the prior art. For example, the electric apparatus may include but is not limited to: notebook computers, pen-input computers, mobile computers, e-book players, portable phones, portable fax machines, portable copiers, portable printers, headphone stereos, video recorders, liquid crystal televisions, portable cleaners, portable CD players, mini discs, transceivers, electronic organizers, calculators, memory cards, portable sound recorders, radios, backup power sources, motors, automobiles, motorcycles, power-assisted bicycles, bicycles, lighting fixtures, toys, game consoles, clocks, electric tools, flashlights, cameras, household large-scale storage batteries, and lithium-ion capacitors.

### EXAMPLES

The following provides examples and comparative examples to more specifically illustrate some embodiments of the present application. Various tests and evaluations were performed according to the following methods.

### Test Methods and Devices:

### Test for Relevant Particle Sizes:

The average particle sizes of the first polymer binder and the second polymer binder could be tested in the following way: a scanning electron microscopy (SEM) was used to observe a corresponding surface of the separator perpendicular to the thickness direction, 10 first polymer binder or second polymer binder particles were arbitrarily selected for measuring their equivalent diameters, an average value was calculated. The first polymer binder and the second polymer binder were distinguished according to particle diameters. Specifically, on two surfaces of the separator, a side with a relatively smaller particle diameter was the first adhesive coating containing the first polymer binder, and 10 first polymer binder particles were arbitrarily selected from the first adhesive coating to obtain the average particle size of the first polymer binder; and a side with a relatively larger particle diameter was the second adhesive coating containing the second polymer binder, and 10 second polymer binder particles were arbitrarily selected from the second adhesive coating to obtain the average particle size of the second polymer binder. It was worth noting that due to deformation of the particles of the first polymer binder and the second polymer binder under pressure during cold pressing, hot pressing, and other processes in the preparation process of the secondary battery, the diameters of the particles along the thickness direction of the separator and a direction perpendicular to the thickness direction of the separator were different, and the average particle sizes of the first polymer binder and the second polymer binder in the present application were diameters measured on surfaces of the particles perpendicular to the thickness direction of the separator. Therefore, the average particle sizes of the first polymer binder and the second polymer binder were not limited by the thicknesses of a first adhesive layer and a second adhesive layer.

The average particle size of the ceramic particles on the separator could be tested in the following way: a SEM was used to observe a cross section of the separator subjected to argon ion polishing or embedding sectioning, diameters of 10 ceramic particles were measured, and an average value was calculated.

A laser particle size analyzer was used to measure the Dᵥ50 and Dᵥ99 of the positive electrode active material and the negative electrode active material respectively.

### Test for Single-Side Coating Weight of First Adhesive Coating:

The lithium-ion batteries of the examples and comparative examples were each discharged at 0.5 C to 3.0 V and then disassembled to obtain a separator, and impurities on a surface of the separator were cleaned with DMC, followed by drying at 60° C. to obtain a test sample of the separator. A small disc with an area of S mm² was obtained by punching the test sample of the separator and weighed to obtain a mass, which was recorded as m₁, then a first adhesive coating on the small disc was peeled off, and a mass of the small disc after the first adhesive coating was peeled off was recorded as m₂. Single-side coating weight of first adhesive coating=(m₁−m₂)/S.

### Test for Single-Side Coating Weight of Second Adhesive Coating:

The lithium-ion batteries of the examples and comparative examples were discharged at 0.5 C to 3.0 V and then disassembled to obtain a separator, and impurities on a surface of the separator were cleaned with DMC, followed by drying at 60° C. to obtain a test sample of the separator. A small disc with an area of S mm² was obtained by punching the test sample of the separator and weighed to obtain a mass, which was recorded as m₃, then a second adhesive coating on the small disc was peeled off, and a mass of the small disc after the second adhesive coating was peeled off was recorded as m₄. Single-side coating weight of second adhesive coating=(m₃−m₄)/S.

### Thickness Test for First Adhesive Coating and Second Adhesive Coating:

Argon ion polishing or embedding sectioning was performed on the coated separator to obtain a cross section of the separator, and a SEM was used to observe the cross section for measuring the thicknesses of the first adhesive coating and the second adhesive coating. In the cross section of the separator, a side with a relatively smaller particle diameter was the first adhesive coating containing the first polymer binder, and a side with a relatively larger particle diameter was the second adhesive coating containing the second polymer binder.

### Coverage Rate Test for First Polymer Binder:

A SEM was used to observe a surface of a side of the separator provided with the first adhesive coating, and the coverage rate of the first polymer adhesive was obtained by calculating a ratio of an area of a region occupied by the first polymer binder in an electron microscope photo to an area of an entire sampled region of the separator in the electron microscope photo.

### Coverage Rate Test for Second Polymer Binder:

A SEM was used to observe a surface of a side of the separator provided with the second adhesive coating, and the coverage rate was obtained by calculating a ratio of an area of a region occupied by the second polymer binder in an electron microscope photo to an area of an entire sampled region of the separator in the electron microscope photo.

### Raman (Raman) Test:

A lithium-ion battery was discharged at 0.5 C to 3.0 V and then disassembled to obtain a negative electrode sheet. The negative electrode sheet was washed with dimethyl carbonate and dried. An area of 100 μm×100 μm was selected from a negative electrode active material layer, and a laser microscopic confocal Raman spectrometer (Raman, HR Evolution, HORIBA Scientific Instruments Division) was used to scan negative electrode active material particles in this area to obtain peaks d and peaks g of all negative electrode active material particles in the range of this area. LabSpec software was used to process data to obtain peak intensities of the peak d and peak g of each negative electrode active material particle, which were I_{d} and I_{g} respectively, where a laser wavelength of the Raman spectrometer was in a range of 532 nm to 785 nm. An I_{d}/I_{g} value was an average value of I_{d} to I_{g} ratios of all negative electrode active material particles measured in this range.

### Test for Adhesion Strength F₁ of Separator to Positive Electrode Sheet:

A 180° peel test was used to measure the adhesion strength between the separator and the positive electrode sheet. After the lithium-ion batteries in the tested examples and comparative examples were each discharged at 0.5 C to 3 V and then disassembled, the negative electrode sheet was peeled off. The separator and the positive electrode sheet were soaked in dimethyl carbonate for 20 min to remove the electrolyte. Then, the separator and the positive electrode sheet were cut into a sample with dimensions of 54.2 mm×72.5 mm. The separator and the positive electrode sheet were laminated, and hot-pressed using a hot pressing machine at 85° C. and 1 MPa for 85 s. The laminated sample was cut into small strips with dimensions of 15 mm×54.2 mm to obtain test sample strips for testing the adhesion strength of the separator to the positive electrode sheet. A double-sided tape with dimensions of 15 mm×55 mm (NITTO.NO5000NS) was adhered to a steel plate, and then the test sample strip was adhered to the double-sided tape, with a test surface facing down. A paper tape with dimensions of 15 mm×70 mm was connected to one end of the test sample strip through the double-sided tape. A 2 kg small stick was manually pushed to roll the test sample strip 8 times to obtain a test sample. A tensile machine was used for testing. The test sample was fixed to a test bench, and the paper tape was folded 180° upward and fixed with a clamp. Subsequently, the tensile machine was started to pull the paper tape at a speed of 50 mm/min until the separator and the positive electrode sheet on a surface of the double-sided tape were separated, then the test was ended, and the test data was stored. The adhesion strength F₁ between the separator and the positive electrode sheet was calculated according to a pulling force and a pulling displacement when the separator and the positive electrode sheet were separated, which was measured in N/m.

### Test for Adhesion Strength F₂ of Separator to Negative Electrode Sheet:

A 180° peel test was used to measure the dry-pressing adhesion strength between the separator and the negative electrode sheet. After the lithium-ion batteries in the tested examples and comparative examples were each discharged at 0.5 C to 3.0 V and then disassembled, the positive electrode sheet was peeled off. The separator and the negative electrode sheet were soaked in dimethyl carbonate for 20 min to remove the electrolyte. Then, the separator and the negative electrode sheet were cut into a sample with dimensions of 54.2 mm×72.5 mm. The separator and the negative electrode sheet were laminated and hot-pressed using a hot pressing machine at 85° C. and 1 MPa for 85 s. The laminated sample was cut into small strips with dimensions of 15 mm×54.2 mm to obtain test sample strips for testing the adhesion strength of the separator to the negative electrode sheet. Then, the adhesion strength F₂ between the separator and the negative electrode sheet was measured according to the above process for testing the adhesion strength of the separator to the positive electrode sheet, which was measured in N/m.

### Test for Cycling Kinetic Performance:

The cycling kinetic performance of the lithium-ion batteries of the examples and comparative examples were tested at a charging rate of 10 C according to the following specific steps:
1. A test temperature was adjusted to a constant temperature of 25° C., a temperature sensing line of a multi-channel thermometer was placed at the center of a surface of the lithium-ion battery, and the following steps were performed: (1) the lithium-ion battery was charged at a constant current of 10 C to 4.2 V; (2) the lithium-ion battery was charged at a constant current of 8 C to 4.3 V; (3) the lithium-ion battery was charged at a constant current of 6 C to 4.45 V; (4) the lithium-ion battery was charged at a constant voltage of 4.45 V to 0.05 C; (5) the lithium-ion battery was left standing for 30 min; (6) the lithium-ion battery was discharged at a constant current of 1 C to 3.0 V; and (7) the lithium-ion battery was left standing for 30 min, and then the process was ended.

Charging speed: a time from process step (1) to process step (4) in step 1.

Charging temperature rise: a difference between a maximum temperature recorded by the temperature sensing line on the surface of the lithium-ion battery during the process from process step (1) to process step (4) in step 1 and the room temperature.
2. The test temperature was adjusted to a constant temperature of 25° C., and then testing was started: (1) the lithium-ion battery was charged at a constant current of 10 C to 4.2 V; (2) the lithium-ion battery was charged at a constant current of 8 C to 4.3 V; (3) the lithium-ion battery was charged at a constant current of 6 C to 4.45 V; (4) the lithium-ion battery was charged at a constant voltage of 4.45 V to 0.05 C; (5) the lithium-ion battery was left standing for 5 min; (6) the lithium-ion battery was discharged at a constant current of 1 C to 3.0 V; (7) the lithium-ion battery was left standing for 5 min; and (8) the process step (1) to process step (7) were repeated for 1000 cycles (cls), and then the process was ended.

$$Capacity retention rate ( \% ) = discharge capacity after 1000 cls / first - cycle discharge capacity \times 100 \% .$$

The cycling kinetic performance is characterized by the charging speed, charging temperature rise, and capacity retention rate, where a shorter charging time results in a smaller charging temperature rise, indicating better initial kinetic performance of the lithium-ion battery; and a higher capacity retention rate indicates better cycling performance of the lithium-ion battery.

### Test for High-Temperature Stability:

A thickness of a prepared lithium-ion battery was tested, which was briefly referred to as an initial thickness of the lithium-ion battery.

The lithium-ion battery was fully charged according to the following steps: the lithium-ion battery was charged at a constant current of 0.7 C to 4.45 V, and charged at a constant voltage of 4.45 V to 0.02 C.

The lithium-ion battery was stored in a high and low temperature box at 85° C. for 8 h, then the thickness of the lithium-ion battery was tested after the storage, and then the test was ended.

Swelling rate of lithium-ion battery=(thickness of lithium-ion battery after high-temperature storage-initial thickness of the lithium-ion battery)/initial thickness of lithium-ion battery×100%. The high-temperature stability is characterized by the swelling rate, where a smaller swelling rate indicates high-temperature stability.

### Example 1-1

### <Preparation of Separator>

A single polypropylene film layer with a thickness of 7 μm was used as the separator substrate.

Ceramic particles boehmite, a ceramic coating binder butadiene-styrene polymer (a mass ratio of butadiene to styrene was 1:1, and weight average molecular weight Mw=7×10⁶), and a solvent deionized water were mixed at a mass ratio of 35:10:55. Specifically: a total of 30 kg of the butadiene-styrene polymer and deionized water was first added to a 60 L twin planetary mixer, and dispersed at 45° C. for 3 hours. Then, 16.1 kg of boehmite ceramic particles were added to the mixer, and dispersed at a high speed at 45° C. for 2 hours. Subsequently, a nano grinder was used for ball milling for 1.5 hours, with spherical zirconia beads with a diameter of 6 μm being used as a grinding medium, to obtain a ceramic coating slurry, where an average particle size of the boehmite ceramic particles was equal to 2 μm.

A first polymer binder polyacrylic acid (Mw=3×10³), a thickener sodium carboxymethyl cellulose (Mw=80000), and a wetting agent polyoxyethylene ether (Mw=6×10³) were mixed at a mass ratio of 91:0.5:8.5, deionized water was added as a solvent, and the resulting mixture was stirred uniformly to form a first adhesive coating slurry with a solid content of 75 wt %; where an average particle size of the first polymer binder was equal to 1.6 μm; and the first polymer binder was a non-core-shell structure.

A second polymer binder polyvinylidene fluoride (Mw=8×10⁵) and an auxiliary binder methacrylic acid were mixed at a mass ratio of 90:10, deionized water was added as a solvent, and the resulting mixture was stirred uniformly to form a second adhesive coating slurry with a solid content of 75 wt %; where an average particle size of the second polymer binder was equal to 25 μm; and the second polymer binder was a non-core-shell structure.

One surface of the separator substrate was coated with the ceramic coating slurry, followed by drying at 60° C. to form a ceramic coating on one surface of the separator substrate. A surface of the ceramic coating away from the separator substrate was coated with the second adhesive coating slurry, followed by drying at 60° C. to form a second adhesive coating on the surface of the ceramic coating away from the separator substrate. The other surface of the separator substrate was coated with the first adhesive coating slurry, followed by drying at 60° C. to form a first adhesive coating on the other surface of the separator substrate. Then, a separator was prepared (for structure, reference is made to FIG. 4, but is not limited to FIG. 4).

The single-side coating weight Cw₁ of the first adhesive coating was equal to 0.0006 mg/mm², the thickness H₁ of the first adhesive coating was equal to 2 μm, the single-side coating weight Cw₂ of the second adhesive coating was equal to 0.0012 mg/mm², and the thickness H₂ of the second adhesive coating was equal to 12 μm. The single-side coating weight Cw₃ of the ceramic coating was equal to 0.0023 mg/mm², and the thickness H₃ of the ceramic coating was equal to 1 μm. The coverage rate Cr₁ of the first polymer binder in the first adhesive coating per unit area was equal to 50%, and the coverage rate Cr₂ of the second polymer binder in the second adhesive coating per unit area was equal to 50%.

### <Preparation of Positive Electrode Sheet>

A positive electrode active material lithium cobalt oxide, a positive electrode conductive agent single-walled carbon nanotubes, and a positive electrode binder polyvinylidene fluoride (PVDF, Mw=6×10⁶) were mixed at a mass ratio of 95:3:2, N-methylpyrrolidone (NMP) was added as a solvent, and the resulting mixture was stirred in a vacuum mixer to obtain a positive electrode slurry with a solid content of 75 wt % and a uniform system. One surface of a 10 μm thick positive electrode current collector aluminum foil was uniformly coated with the positive electrode slurry, followed by drying at 95° C. to obtain a positive electrode sheet having one surface coated with a positive electrode active material layer. Then, the above steps were repeated on the other surface of the aluminum foil to obtain a positive electrode sheet having both surfaces coated with the positive electrode active material layer. Then, cold pressing, cutting, and slitting were performed. After slitting, drying was performed at 85° C. for 4 h under vacuum to obtain a positive electrode sheet with specifications of 50 mm×1300 mm for later use. A thickness of each positive electrode active material layer was 38.5 μm, and a thickness of the positive electrode sheet was 87 μm. 18 positive electrode tabs were integrally formed in a tab region of the positive electrode current collector through die cutting. A compacted density of the positive electrode sheet was 4.0 g/cm³. The Dᵥ99 of the lithium cobalt oxide was equal to 30 μm, and the Dᵥ50 was equal to 13 μm.

### <Preparation of Negative Electrode Sheet>

A negative electrode active material, a dispersant sodium carboxymethyl cellulose (CMC-Na, Mw=7×10⁵), and a negative electrode binder styrene-butadiene rubber (SBR, Mw=5×10⁶) were mixed at a mass ratio of 97.5:1.0:1.5, then deionized water was added as a solvent, and the resulting mixture was stirred in a vacuum mixer to obtain a negative electrode slurry with a solid content of 51 wt % and a uniform system. One surface of a 6 μm thick negative electrode current collector copper foil was uniformly coated with the negative electrode slurry, followed by drying at 85° C. to obtain a negative electrode sheet having one surface coated with a negative electrode active material layer. Then, the above steps were repeated on the other surface of the copper foil to obtain a negative electrode sheet having both surfaces coated with the negative electrode active material layer. Then, cold pressing, cutting, and slitting were performed. After slitting, drying was performed at 110° C. for 4 h under vacuum to obtain a negative electrode sheet with specifications of 56 mm×1350 mm for later use. A thickness of each negative electrode active material layer was 58.5 μm, and a thickness of the negative electrode sheet was 123 μm. 18 negative electrode tabs were integrally formed in a tab region of the negative electrode current collector through die cutting. A compacted density of the negative electrode sheet was 1.5 g/cm³. The Dᵥ99 of the negative electrode active material was equal to 25 μm, and the Dᵥ50 was equal to 9 μm. The type of the negative electrode active material is shown in Table 5.

### <Preparation of Electrolyte>

In an environment with a water content of less than 10 ppm, a lithium salt, an organic solvent, and an additive were proportioned at a mass ratio of 9:90:1 to obtain an electrolyte. The lithium salt used was lithium hexafluorophosphate, the additive used was ethanedinitrile, and the organic solvent used was n-propyl propionate, ethylene carbonate, or diethyl carbonate. A mass ratio of the n-propyl propionate, ethylene carbonate, and diethyl carbonate was 40:30:30. Based on a mass of the electrolyte, mass percentage W₁ of linear carboxylate ester=40%×90%=36%, mass percentage W₂ of ethylene carbonate=30%×90%=27%, and mass percentage W₃ of diethyl carbonate=30%×90%=27%.

### <Preparation of Lithium-Ion Battery>

The separator, positive electrode sheet, separator, and negative electrode sheet were stacked in sequence, where the separator was located between the positive electrode sheet and the negative electrode sheet for separation, the first adhesive coating in the separator was close to the negative electrode sheet, and the second adhesive coating was close to the positive electrode sheet; and then winding was performed to obtain an electrode assembly. The electrode assembly was placed in an aluminum-plastic film case and dried, and then an electrolyte was injected, followed by processes such as vacuum sealing, standing, formation, capacity testing, degassing, and trimming, to obtain a lithium-ion battery.

### Examples 1-2 to 1-22

Examples 1-2 to 1-22 were the same as Example 1-1, except that the relevant preparation parameters were adjusted according to Table 1.

When the mass percentage of the linear carboxylate ester changed, the mass percentages of the ethylene carbonate and diethyl carbonate changed accordingly, and the mass ratio of the lithium salt, organic solvent, and additive remained unchanged. The sum of the mass percentages of the linear carboxylate ester, ethylene carbonate, and diethyl carbonate W₁+W₂+W₃ was equal to 90%, and W₂=W₃. The sum of the mass percentages of the lithium salt, organic solvent, and additive was 100%.

### Example 1-23

Example 1-23 was the same as Example 1-1 except that the mass ratio of the lithium salt, organic solvent, and additive was adjusted to 32:60:8 in the <preparation of electrolyte>.

### Example 1-24

Example 1-24 was the same as Example 1-1 except that the mass ratio of the lithium salt, organic solvent, and additive was adjusted to 16:80:4 in the <preparation of electrolyte>.

### Example 1-25

Example 1-25 was the same as Example 1-1 except that the mass ratio of the lithium salt, organic solvent, and additive was adjusted to 40:50:10 in the <preparation of electrolyte>.

### Example 1-26

Example 1-26 was the same as Example 1-1 except that the mass ratio of the lithium salt, organic solvent, and additive was adjusted to 4:95:1 in the <preparation of electrolyte>.

### Examples 1-27 to 1-30

Examples 1-27 to 1-30 were the same as Example 1-1 except that the relevant preparation parameters were adjusted according to Table 1.

### Example 1-31

Example 1-31 was the same as Example 1-1 except that the first adhesive coating in the separator was close to the positive electrode sheet and the second adhesive coating was close to the negative electrode sheet in the <preparation of lithium-ion battery>.

### Examples 1-32 to 1-34

Examples 1-32 to 1-34 were the same as Example 1-1 except that the relevant preparation parameters were adjusted according to Table 1.

### Examples 2-1 to 2-12

Examples 2-1 to 2-12 were the same as Example 1-1 except that the relevant preparation parameters were adjusted according to Table 3.

### Example 3-1

Example 3-1 was the same as Example 1-1 except that the relevant preparation parameters were adjusted according to Table 5.

### Examples 3-2 to 3-4

Examples 3-2 to 3-4 were the same as Example 1-1 except that artificial graphite having a surface coated with amorphous carbon was used as the negative electrode active material in the <preparation of negative electrode sheet>, where the mass ratio of artificial graphite to amorphous carbon was adjusted according to Table 5.

### Example 3-5 and Example 3-6

Example 3-5 and Example 3-6 were the same as Example 1-1 except that the relevant preparation parameters were adjusted according to Table 5.

### Comparative Examples 1 to 10

Comparative Examples 1 to 10 were the same as Example 1-1 except that the relevant preparation parameters were adjusted according to Table 1.

When the mass percentage of the linear carboxylate ester changed, the mass percentages of the ethylene carbonate and diethyl carbonate changed accordingly, and the mass ratio of the lithium salt, organic solvent, and additive remained unchanged. The sum of the mass percentages of the linear carboxylate ester, ethylene carbonate, and diethyl carbonate W₁+W₂+W₃ was equal to 90%, and W₂=W₃. The sum of the mass percentages of the lithium salt, organic solvent, and additive was 100%.

### Comparative Example 11

### <Preparation of Separator>

One surface of the separator substrate was coated with the ceramic coating slurry, followed by drying at 60° C. to form a ceramic coating on one surface of the separator substrate; a surface of the ceramic coating away from the separator substrate was coated with the first adhesive coating slurry, followed by drying at 60° C. to form a first adhesive coating on the surface of the ceramic coating away from the separator substrate; the other surface of the separator substrate was coated with the first adhesive coating slurry, followed by drying at 60° C. to form a first adhesive coating on the other surface of the separator substrate; and then a separator was prepared.

The rest were the same as those of Example 1-1.

### <Preparation of Lithium-Ion Battery>

The preparation was the same as that of Example 1-1 except that the surface of the separator provided with the ceramic coating was closer to the positive electrode sheet.

The <preparation of positive electrode sheet>, <preparation of negative electrode sheet>, and <preparation of electrolyte> were the same as those of Comparative Example 1.

### Comparative Example 12

### <Preparation of Separator>

One surface of the separator substrate was coated with the ceramic coating slurry, followed by drying at 60° C. to form a ceramic coating on one surface of the separator substrate; a surface of the ceramic coating away from the separator substrate was coated with the second adhesive coating slurry, followed by drying at 60° C. to form a second adhesive coating on the surface of the ceramic coating away from the separator substrate; the other surface of the separator substrate was coated with the second adhesive coating slurry, followed by drying at 60° C. to form a second adhesive coating on the other surface of the separator substrate; and then a separator was prepared.

The rest were the same as those of Example 1-1.

The <preparation of positive electrode sheet>, <preparation of negative electrode sheet>, <preparation of electrolyte>, and <preparation of lithium-ion battery> were the same as those of Comparative Example 11.

### Comparative Example 13

Comparative Example 13 was the same as Example 1-1 except that the relevant preparation parameters were adjusted according to Table 1.

When the mass percentage of the linear carboxylate ester changed, the mass percentages of the ethylene carbonate and diethyl carbonate changed accordingly, and the mass ratio of the lithium salt, organic solvent, and additive remained unchanged. The sum of the mass percentages of the linear carboxylate ester, ethylene carbonate, and diethyl carbonate W₁+W₂+W₃ was equal to 90%, and W₂=W₃. The sum of the mass percentages of the lithium salt, organic solvent, and additive was 100%.

### Comparative Example 14

The <preparation of separator> and <preparation of lithium-ion battery> were the same as those of Comparative Example 11.

The <preparation of positive electrode sheet>, <preparation of negative electrode sheet>, and <preparation of electrolyte> were the same as those of Comparative Example 13.

### Comparative Example 15

The <preparation of separator> and <preparation of lithium-ion battery> were the same as those of Comparative Example 12.

The <preparation of positive electrode sheet>, <preparation of negative electrode sheet>, and <preparation of electrolyte> were the same as those of Comparative Example 13.

The preparation parameters and performance parameters of the examples and comparative examples are shown in Tables 1 to 5.

TABLE 1

| | Dᵥ99 | Dᵥ50 | Dᵥ99 | Dᵥ50 | Average | | | Mass | |
|---|---|---|---|---|---|---|---|---|---|
| | of | of | of | of | particle | Average | Mass | percentage | |
| | positive | positive | negative | negative | size of | particle size | percentage | of | Type |
| | electrode | electrode | electrode | electrode | first | of second | of | linear | of |
| | active | active | active | active | polymer | polymer | organic | carboxylate | linear |
| | material | material | material | material | binder | binder | solvent | ester | carboxylate |
| | (μm) | (μm) | (μm) | (μm) | (μm) | (μm) | (%) | (%) | ester |
| Example | 30 | 13 | 25 | 9 | 1.6 | 25 | 90 | 36 | N-propyl |
| 1-1 | | | | | | | | | propionate |
| Example | 27 | 10 | 25 | 9 | 1.6 | 25 | 90 | 36 | N-propyl |
| 1-2 | | | | | | | | | propionate |
| Example | 28 | 11 | 25 | 9 | 1.6 | 25 | 90 | 36 | N-propyl |
| 1-3 | | | | | | | | | propionate |
| Example | 31 | 14 | 25 | 9 | 1.6 | 25 | 90 | 36 | N-propyl |
| 1-4 | | | | | | | | | propionate |
| Example | 33 | 15 | 25 | 9 | 1.6 | 25 | 90 | 36 | N-propyl |
| 1-5 | | | | | | | | | propionate |
| Example | 30 | 13 | 23 | 7 | 1.6 | 25 | 90 | 36 | N-propyl |
| 1-6 | | | | | | | | | propionate |
| Example | 30 | 13 | 24 | 8 | 1.6 | 25 | 90 | 36 | N-propyl |
| 1-7 | | | | | | | | | propionate |
| Example | 30 | 13 | 26 | 10 | 1.6 | 25 | 90 | 36 | N-propyl |
| 1-8 | | | | | | | | | propionate |
| Example | 30 | 13 | 28 | 12 | 1.6 | 25 | 90 | 36 | N-propyl |
| 1-9 | | | | | | | | | propionate |
| Example | 30 | 13 | 25 | 9 | 0.3 | 25 | 90 | 36 | N-propyl |
| 1-10 | | | | | | | | | propionate |
| Example | 30 | 13 | 25 | 9 | 0.6 | 25 | 90 | 36 | N-propyl |
| 1-11 | | | | | | | | | propionate |
| Example | 30 | 13 | 25 | 9 | 1.0 | 25 | 90 | 36 | N-propyl |
| 1-12 | | | | | | | | | propionate |
| Example | 30 | 13 | 25 | 9 | 3 | 25 | 90 | 36 | N-propyl |
| 1-13 | | | | | | | | | propionate |
| Example | 30 | 13 | 25 | 9 | 1.6 | 10 | 90 | 36 | N-propyl |
| 1-14 | | | | | | | | | propionate |
| Example | 30 | 13 | 25 | 9 | 1.6 | 20 | 90 | 36 | N-propyl |
| 1-15 | | | | | | | | | propionate |
| Example | 30 | 13 | 25 | 9 | 1.6 | 30 | 90 | 36 | N-propyl |
| 1-16 | | | | | | | | | propionate |
| Example | 30 | 13 | 25 | 9 | 1.6 | 38 | 90 | 36 | N-propyl |
| 1-17 | | | | | | | | | propionate |
| Example | 30 | 13 | 25 | 9 | 1.6 | 25 | 90 | 6 | N-propyl |
| 1-18 | | | | | | | | | propionate |
| Example | 30 | 13 | 25 | 9 | 1.6 | 25 | 90 | 18 | N-propyl |
| 1-19 | | | | | | | | | propionate |
| Example | 30 | 13 | 25 | 9 | 1.6 | 25 | 90 | 27 | N-propyl |
| 1-20 | | | | | | | | | propionate |
| Example | 30 | 13 | 25 | 9 | 1.6 | 25 | 90 | 40 | N-propyl |
| 1-21 | | | | | | | | | propionate |
| Example | 30 | 13 | 25 | 9 | 1.6 | 25 | 90 | 56 | N-propyl |
| 1-22 | | | | | | | | | propionate |
| Example | 30 | 13 | 25 | 9 | 1.6 | 25 | 60 | 24 | N-propyl |
| 1-23 | | | | | | | | | propionate |
| Example | 30 | 13 | 25 | 9 | 1.6 | 25 | 80 | 32 | N-propyl |
| 1-24 | | | | | | | | | propionate |
| Example | 30 | 13 | 25 | 9 | 1.6 | 25 | 50 | 20 | N-propyl |
| 1-25 | | | | | | | | | propionate |
| Example | 30 | 13 | 25 | 9 | 1.6 | 25 | 95 | 38 | N-propyl |
| 1-26 | | | | | | | | | propionate |
| Example | 27 | 8 | 25 | 9 | 1.6 | 25 | 90 | 36 | N-propyl |
| 1-27 | | | | | | | | | propionate |
| Example | 32 | 17 | 25 | 9 | 1.6 | 25 | 90 | 36 | N-propyl |
| 1-28 | | | | | | | | | propionate |
| Example | 30 | 13 | 23 | 5 | 1.6 | 25 | 90 | 36 | N-propyl |
| 1-29 | | | | | | | | | propionate |
| Example | 30 | 13 | 28 | 15 | 1.6 | 25 | 90 | 36 | N-propyl |
| 1-30 | | | | | | | | | propionate |
| Example | 30 | 13 | 25 | 9 | 1.6 | 25 | 90 | 36 | N-propyl |
| 1-31 | | | | | | | | | propionate |
| Example | 30 | 13 | 25 | 9 | 1.6 | 25 | 90 | 36 | N-butyl |
| 1-32 | | | | | | | | | butyrate |
| Example | 30 | 13 | 25 | 9 | 1.6 | 25 | 90 | 36 | Methyl |
| 1-33 | | | | | | | | | formate |
| Example | 30 | 13 | 25 | 9 | 1.6 | 25 | 90 | 36 | Ethyl |
| 1-34 | | | | | | | | | butyrate |
| Comparative | 30 | 13 | 25 | 9 | 1.6 | 25 | 90 | 3 | N-propyl |
| Example 1 | | | | | | | | | propionate |
| Comparative | 30 | 13 | 25 | 9 | 1.6 | 25 | 90 | 63 | N-propyl |
| Example 2 | | | | | | | | | propionate |
| Comparative | 30 | 13 | 25 | 9 | 1.6 | 5 | 90 | 36 | N-propyl |
| Example 3 | | | | | | | | | propionate |
| Comparative | 30 | 13 | 25 | 9 | 1.6 | 43 | 90 | 36 | N-propyl |
| Example 4 | | | | | | | | | propionate |
| Comparative | 30 | 13 | 25 | 9 | 0.1 | 25 | 90 | 36 | N-propyl |
| Example 5 | | | | | | | | | propionate |
| Comparative | 30 | 13 | 25 | 9 | 4 | 25 | 90 | 36 | N-propyl |
| Example 6 | | | | | | | | | propionate |
| Comparative | 30 | 13 | 20 | 4 | 1.6 | 25 | 90 | 36 | N-propyl |
| Example 7 | | | | | | | | | propionate |
| Comparative | 30 | 13 | 30 | 14 | 1.6 | 25 | 90 | 36 | N-propyl |
| Example 8 | | | | | | | | | propionate |
| Comparative | 25 | 8 | 25 | 9 | 1.6 | 25 | 90 | 36 | N-propyl |
| Example 9 | | | | | | | | | propionate |
| Comparative | 35 | 18 | 25 | 9 | 1.6 | 25 | 90 | 36 | N-propyl |
| Example 10 | | | | | | | | | propionate |
| Comparative | 30 | 13 | 25 | 9 | 1.6 | \ | 90 | 36 | N-propyl |
| Example 11 | | | | | | | | | propionate |
| Comparative | 30 | 12 | 25 | 9 | \ | 25 | 90 | 36 | N-propyl |
| Example 12 | | | | | | | | | propionate |
| Comparative | 25 | 8 | 20 | 4 | 1.6 | 25 | 90 | 3 | N-propyl |
| Example 13 | | | | | | | | | propionate |
| Comparative | 25 | 8 | 20 | 4 | 1.6 | \ | 90 | 3 | N-propyl |
| Example 14 | | | | | | | | | propionate |
| Comparative | 25 | 8 | 20 | 4 | \ | 25 | 90 | 3 | N-propyl |
| Example 15 | | | | | | | | | propionate |

Note:
The “\” in Table 1 indicates no corresponding parameter. The difference between Example 1-1 and Example 1-31 in Table 1 is that in the lithium-ion battery of Example 1-1, the first adhesive coating in the separator is close to the negative electrode sheet, and the second adhesive coating is close to the positive electrode sheet; and in the lithium-ion battery of Example 1-31, the first adhesive coating in the separator is close to the positive electrode sheet, and the second adhesive coating is close to the negative electrode sheet.

TABLE 2

| | | | | 10C | Capacity | |
|---|---|---|---|---|---|---|
| | | | | charging | retention | |
| | | | 10C | temper- | rate | |
| | | | charging | ature | after 1000 | Swelling |
| | F₁ | F₂ | speed | rise | cls at | rate |
| | (N/m) | (N/m) | (min) | (° C.) | 25° C. (%) | (%) |
| Example 1-1 | 8.1 | 12.3 | 15.32 | 18.72 | 85.2 | 8.3 |
| Example 1-2 | 8.3 | 12.2 | 15.14 | 18.53 | 80.6 | 10.5 |
| Example 1-3 | 8.5 | 12.3 | 15.22 | 18.64 | 83.4 | 9.0 |
| Example 1-4 | 8.4 | 12.5 | 15.44 | 18.86 | 83.2 | 8.2 |
| Example 1-5 | 8.0 | 12.3 | 16.66 | 19.42 | 80.4 | 8.2 |
| Example 1-6 | 8.6 | 11.9 | 15.25 | 18.67 | 80.6 | 9.8 |
| Example 1-7 | 8.3 | 12.6 | 15.34 | 18.84 | 82.4 | 8.8 |
| Example 1-8 | 8.4 | 12.3 | 15.48 | 18.88 | 83.8 | 8.2 |
| Example 1-9 | 8.1 | 12.0 | 16.53 | 19.32 | 80.2 | 8.3 |
| Example 1-10 | 8.7 | 10.1 | 15.39 | 18.74 | 80.2 | 13.5 |
| Example 1-11 | 8.3 | 10.7 | 15.32 | 18.76 | 85.1 | 9.6 |
| Example 1-12 | 8.5 | 11.5 | 15.35 | 18.71 | 85.3 | 8.7 |
| Example 1-13 | 8.1 | 14.2 | 15.81 | 19.27 | 80.6 | 8.2 |
| Example 1-14 | 6.5 | 12.1 | 15.36 | 18.74 | 81.0 | 14.6 |
| Example 1-15 | 7.6 | 12.3 | 15.34 | 18.78 | 84.3 | 10.4 |
| Example 1-16 | 9.1 | 12.2 | 15.32 | 18.72 | 84.2 | 8.0 |
| Example 1-17 | 10.6 | 12.5 | 16.37 | 19.75 | 77.3 | 8.2 |
| Example 1-18 | 8.1 | 12.4 | 17.34 | 20.83 | 70.4 | 5.9 |
| Example 1-19 | 8.5 | 12.0 | 16.58 | 19.56 | 83.2 | 6.7 |
| Example 1-20 | 8.4 | 12.2 | 16.04 | 19.14 | 84.1 | 7.5 |
| Example 1-21 | 8.6 | 12.1 | 14.82 | 17.65 | 85.7 | 9.7 |
| Example 1-22 | 8.2 | 12.1 | 14.26 | 16.97 | 80.9 | 16.7 |
| Example 1-23 | 8.4 | 12.3 | 16.33 | 19.28 | 80.2 | 6.5 |
| Example 1-24 | 8.2 | 12.4 | 15.47 | 18.91 | 83.4 | 7.9 |
| Example 1-25 | 8.2 | 12.0 | 16.64 | 20.88 | 77.4 | 6.2 |
| Example 1-26 | 8.3 | 12.5 | 14.98 | 18.54 | 76.5 | 10.8 |
| Example 1-27 | 8.4 | 12.1 | 15.13 | 18.63 | 78.6 | 11.2 |
| Example 1-28 | 8.7 | 12.4 | 16.42 | 19.92 | 79.5 | 8.1 |
| Example 1-29 | 8.5 | 12.3 | 15.12 | 18.62 | 77.4 | 10.3 |
| Example 1-30 | 8.3 | 12.3 | 16.33 | 19.83 | 78.5 | 8.1 |
| Example 1-31 | 12.1 | 4.0 | 15.24 | 18.75 | 77.1 | 16.2 |
| Example 1-32 | 8.1 | 12.1 | 15.22 | 18.76 | 83.4 | 8.3 |
| Example 1-33 | 8.5 | 12.2 | 15.31 | 18.73 | 84.1 | 8.5 |
| Example 1-34 | 8.3 | 12.5 | 15.24 | 18.87 | 82.6 | 8.3 |
| Comparative | 8.2 | 12.4 | 23.25 | 23.46 | 44.2 | 6.9 |
| Example 1 | | | | | | |
| Comparative | 8.1 | 12.3 | 13.77 | 16.59 | 76.2 | 23.9 |
| Example 2 | | | | | | |
| Comparative | 1.4 | 12.1 | 15.29 | 18.73 | 63.2 | 18.7 |
| Example 3 | | | | | | |
| Comparative | 11.6 | 12.4 | 17.25 | 21.72 | 54.3 | 8.0 |
| Example 4 | | | | | | |
| Comparative | 8.4 | 3.5 | 15.26 | 18.75 | 72.4 | 16.5 |
| Example 5 | | | | | | |
| Comparative | 8.2 | 14.9 | 17.22 | 21.75 | 65.4 | 8.1 |
| Example 6 | | | | | | |
| Comparative | 8.5 | 12.2 | 15.24 | 18.52 | 69.3 | 14.4 |
| Example 7 | | | | | | |
| Comparative | 8.7 | 12.6 | 17.66 | 21.03 | 64.2 | 8.2 |
| Example 8 | | | | | | |
| Comparative | 8.4 | 12.4 | 15.13 | 18.45 | 68.6 | 15.3 |
| Example 9 | | | | | | |
| Comparative | 8.3 | 12.5 | 17.76 | 21.04 | 65.4 | 8.2 |
| Example 10 | | | | | | |
| Comparative | 12.5 | 12.1 | 15.44 | 18.82 | 43.1 | 8.1 |
| Example 11 | | | | | | |
| Comparative | 8.6 | 1.8 | 15.28 | 18.73 | 75.2 | 20.2 |
| Example 12 | | | | | | |
| Comparative | 8.3 | 12.5 | 23.14 | 23.11 | 44.2 | 10.9 |
| Example 13 | | | | | | |
| Comparative | 12.7 | 12.3 | 23.22 | 13.35 | 30.1 | 8.6 |
| Example 14 | | | | | | |
| Comparative | 8.5 | 1.9 | 23.16 | 23.16 | 45.6 | 7.4 |
| Example 15 | | | | | | |

From Examples 1-1 to 1-34 and Comparative Examples 1 to 15, it can be seen that in the secondary battery of some embodiments of the present application, a first adhesive coating and a second adhesive coating are respectively provided on two sides of the separator, the average particle size of the first polymer binder in the first adhesive coating and the average particle size of the second polymer binder in the second adhesive coating are within the ranges provided in the present application, the Dᵥ99 of the positive electrode active material and the Dᵥ99 of the negative electrode active material are within the ranges provided in the present application, and the percentage of the linear carboxylate ester in the electrolyte is within the ranges provided in the present application, so that the separator has higher adhesion strength F₁ to the positive electrode sheet and higher adhesion strength F₂ to the negative electrode sheet, the secondary battery can simultaneously have a shorter charging time (that is, higher charging speed), a lower charging temperature rise, and a higher capacity retention rate at a charging rate of 10 C, and the secondary battery has a lower swelling rate after storage at 85° C. for 8 h. This indicates that the secondary battery of some embodiments of the present application can guarantee high-temperature stability while having good cycling kinetic performance under superfast charging conditions, that is, the secondary battery has better comprehensive performance under superfast charging conditions. For the secondary batteries of Comparative Example 1 and Comparative Example 2, the percentage of the linear carboxylate ester in the electrolyte is not within the ranges provided in the present application; for the secondary batteries of Comparative Example 3 and Comparative Example 4, the average particle size of the second polymer binder in the separator is not within the ranges provided in the present application; for the secondary batteries of Comparative Example 5 and Comparative Example 6, the average particle size of the first polymer binder in the separator is not within the ranges provided in the present application; for the secondary batteries of Comparative Example 7 and Comparative Example 8, the Dᵥ99 of the negative electrode active material is not within the ranges provided in the present application; for the secondary batteries of Comparative Example 9 and Comparative Example 10, the Dᵥ99 of the positive electrode active material is not within the ranges provided in the present application; for the secondary battery of Comparative Example 11, two sides of the separator are each configured as the first adhesive coating, rather than the separator structure of the present application; for the secondary battery of Comparative Example 12, two sides of the separator are each configured as the second adhesive coating, rather than the separator structure of the present application; for the secondary battery of Comparative Example 13, the Dᵥ99 of the positive electrode active material and the Dᵥ99 of the negative electrode active material are not within the ranges provided in the present application, and the percentage of the linear carboxylate ester in the electrolyte is not within the ranges provided in the present application; for the secondary batteries of Comparative Example 14 and Comparative Example 15, the Dᵥ99 of the positive electrode active material, the Dᵥ99 of the negative electrode active material, the percentage of the linear carboxylate ester in the electrolyte, and the separator are all not within the ranges provided in the present application; and the secondary batteries of Comparative Examples 1 to 15 have a longer charging time (that is, lower charging speed), and/or a higher charging temperature rise, and/or a lower capacity retention rate at a charging rate of 10 C, or the secondary batteries have a higher swelling rate in thickness after storage at 85° C. for 8 h, indicating that the secondary batteries cannot guarantee all of the charging time, the charging temperature rise, the capacity retention rate, and the swelling rate under superfast charging conditions, that is, the secondary batteries cannot guarantee both the cycling kinetic performance and high-temperature stability under superfast charging conditions.

The Dᵥ99 of the positive electrode active material generally affects the cycling kinetic performance and high-temperature stability of the secondary battery. From Examples 1-1 to 1-5, Comparative Example 9, and Comparative Example 10, it can be seen that the secondary battery in which the Dᵥ99 of the positive electrode active material is within the ranges provided in the present application comprehensively has a shorter charging time, a lower charging temperature rise, and a higher capacity retention rate at a charging rate of 10 C, and has a lower swelling rate in thickness after storage at 85° C. for 8 h. Thus, the secondary battery can guarantee high-temperature stability while having good cycling kinetic performance under superfast charging conditions.

The Dᵥ99 of the negative electrode active material generally affects the cycling kinetic performance and high-temperature stability of the secondary battery. From Example 1-1, Examples 1-6 to 1-9, Comparative Example 7, and Comparative Example 8, it can be seen that the secondary battery in which the Dᵥ99 of the negative electrode active material is within the ranges provided in the present application comprehensively has a shorter charging time, a lower charging temperature rise, and a higher capacity retention rate at a charging rate of 10 C, and has a lower swelling rate in thickness after storage at 85° C. for 8 h. Thus, the secondary battery can guarantee high-temperature stability while having good cycling kinetic performance under superfast charging conditions.

The average particle size of the first polymer binder generally affects the cycling kinetic performance and high-temperature stability of the secondary battery. From Example 1-1, Examples 1-10 to 1-13, Comparative Example 5, and Comparative Example 6, it can be seen that the secondary battery in which the average particle size of the first polymer binder is within the ranges provided in the present application comprehensively has a shorter charging time, a lower charging temperature rise, and a higher capacity retention rate at a charging rate of 10 C, and has a lower swelling rate in thickness after storage at 85° C. for 8 h. Thus, the secondary battery can guarantee high-temperature stability while having good cycling kinetic performance under superfast charging conditions.

The average particle size of the second polymer binder generally affects the cycling kinetic performance and high-temperature stability of the secondary battery. From Example 1-1, Examples 1-14 to 1-17, Comparative Example 3, and Comparative Example 4, it can be seen that the secondary battery in which the average particle size of the second polymer binder is within the ranges provided in the present application comprehensively has a shorter charging time, a lower charging temperature rise, and a higher capacity retention rate at a charging rate of 10 C, and has a lower swelling rate in thickness after storage at 85° C. for 8 h. Thus, the secondary battery can guarantee high-temperature stability while having good cycling kinetic performance under superfast charging conditions.

The percentage of the linear carboxylate ester in the electrolyte generally affects the cycling kinetic performance and high-temperature stability of the secondary battery. From Example 1-1, Examples 1-18 to 1-26, Comparative Example 1, and Comparative Example 2, it can be seen that the secondary battery in which the percentage of the linear carboxylate ester in the electrolyte is within the ranges provided in the present application comprehensively has a shorter charging time, a lower charging temperature rise, and a higher capacity retention rate at a charging rate of 10 C, and has a lower swelling rate in thickness after storage at 85° C. for 8 h. Thus, the secondary battery can guarantee high-temperature stability while having good cycling kinetic performance under superfast charging conditions.

The percentage of the organic solvent in the electrolyte generally affects the cycling kinetic performance and high-temperature stability of the secondary battery. From Example 1-1 and Examples 1-23 to 1-26, it can be seen that the secondary battery in which the percentage of the organic solvent in the electrolyte is within the ranges provided in the present application comprehensively has a shorter charging time, a lower charging temperature rise, and a higher capacity retention rate at a charging rate of 10 C, and has a lower swelling rate in thickness after storage at 85° C. for 8 h. Thus, the secondary battery can guarantee high-temperature stability while having good cycling kinetic performance under superfast charging conditions.

The Dᵥ50 of the positive electrode active material generally affects the cycling kinetic performance and high-temperature stability of the secondary battery. From Examples 1-1 to 1-5, Example 1-27, and Example 1-28, it can be seen that the secondary battery in which the Dᵥ50 of the positive electrode active material is within the ranges provided in the present application comprehensively has a shorter charging time, a lower charging temperature rise, and a higher capacity retention rate at a charging rate of 10 C, and has a lower swelling rate in thickness after storage at 85° C. for 8 h. Thus, the secondary battery can guarantee high-temperature stability while having good cycling kinetic performance under superfast charging conditions. Moreover, from Example 1-2 and Example 1-27, it can also be seen that when the positive electrode active materials with the same Dᵥ99 have different Dᵥ50, the cycling kinetic performance and high-temperature stability of the secondary battery are also affected.

The Dᵥ50 of the negative electrode active material generally affects the cycling kinetic performance and high-temperature stability of the secondary battery. From Example 1-1, Examples 1-6 to 1-9, Example 1-29, and Example 1-30, it can be seen that the secondary battery in which the Dᵥ50 of the negative electrode active material is within the ranges provided in the present application comprehensively has a shorter charging time, a lower charging temperature rise, and a higher capacity retention rate at a charging rate of 10 C, and has a lower swelling rate in thickness after storage at 85° C. for 8 h. Thus, the secondary battery can guarantee high-temperature stability while having good cycling kinetic performance under superfast charging conditions. Moreover, from Example 1-6, Example 1-9, Example 1-29, and Example 1-30, it can also be seen that when the negative electrode active materials with the same Dᵥ99 have different Dᵥ50, the cycling kinetic performance and high-temperature stability of the secondary battery are also affected.

The positional relationships between the first and second adhesive coatings in the separator and the positive and negative electrode sheets generally affect the cycling kinetic performance and high-temperature stability of the secondary battery. From Example 1-1 and Example 1-31, it can be seen that the secondary battery in which the positional relationships between the first and second adhesive coatings in the separator and the positive and negative electrode sheets are within the ranges provided in the present application comprehensively has a shorter charging time, a lower charging temperature rise, and a higher capacity retention rate at a charging rate of 10 C, and has a lower swelling rate in thickness after storage at 85° C. for 8 h. Thus, the secondary battery can guarantee high-temperature stability while having good cycling kinetic performance under superfast charging conditions.

The type of the linear carboxylate ester generally affects the cycling kinetic performance and high-temperature stability of the secondary battery. From Example 1-1 and Examples 1-32 to 1-34, it can be seen that the secondary battery in which the type of the linear carboxylate ester is within the ranges provided in the present application comprehensively has a shorter charging time, a lower charging temperature rise, and a higher capacity retention rate at a charging rate of 10 C, and has a lower swelling rate in thickness after storage at 85° C. for 8 h. Thus, the secondary battery can guarantee high-temperature stability while having good cycling kinetic performance under superfast charging conditions.

TABLE 3

| | First | Second | | | | | | |
|---|---|---|---|---|---|---|---|---|
| | polymer | polymer | | | Cw₁ | Cw₂ | H₁ | H₂ |
| | binder | binder | Cr₁ (%) | Cr₂ (%) | (mg/mm²) | (mg/mm²) | (μm) | (μm) |
| Example | Polyacrylic acid | Polyvinylidene fluoride | 50 | 50 | 0.0006 | 0.0012 | 2 | 12 |
| 1-1 | | | | | | | | |
| Example | Polyacrylic acid | Polyvinylidene fluoride | 40 | 50 | 0.0001 | 0.0012 | 0.20 | 12 |
| 2-1 | | | | | | | | |
| Example | Polyacrylic acid | Polyvinylidene fluoride | 60 | 50 | 0.0010 | 0.0012 | 4.0 | 12 |
| 2-2 | | | | | | | | |
| Example | Polyacrylic acid | Polyvinylidene fluoride | 3.3 | 50 | 0.00004 | 0.0012 | 0.13 | 12 |
| 2-3 | | | | | | | | |
| Example | Polyacrylic acid | Polyvinylidene fluoride | 86.4 | 50 | 0.0018 | 0.0012 | 7.2 | 12 |
| 2-4 | | | | | | | | |
| Example | Polyacrylic acid | Polyvinylidene fluoride | 50 | 40 | 0.0006 | 0.0004 | 2 | 5 |
| 2-5 | | | | | | | | |
| Example | Polyacrylic acid | Polyvinylidene fluoride | 50 | 60 | 0.0006 | 0.002 | 2 | 20 |
| 2-6 | | | | | | | | |
| Example | Polyacrylic acid | Polyvinylidene fluoride | 50 | 8.3 | 0.0006 | 0.0002 | 2 | 2 |
| 2-7 | | | | | | | | |
| Example | Polyacrylic acid | Polyvinylidene fluoride | 50 | 91.6 | 0.0006 | 0.0035 | 2 | 29 |
| 2-8 | | | | | | | | |
| Example | Polyacrylonitrile | Polyvinylidene fluoride | 50 | 50 | 0.0006 | 0.0012 | 2 | 12 |
| 2-9 | (Mw = 6000) | | | | | | | |
| Example | Core: polyethyl | Polyvinylidene fluoride | 50 | 50 | 0.0006 | 0.0012 | 2 | 12 |
| 2-10 | acrylate (Mw = | | | | | | | |
| | 9.5 × 10⁴); Shell: | | | | | | | |
| | polymethyl | | | | | | | |
| | acrylate (Mw = | | | | | | | |
| | 4.5 × 10⁴); Core- | | | | | | | |
| | shell mass ratio: | | | | | | | |
| | 1:1 | | | | | | | |
| Example | Polyacrylic acid | Polyvinylidene chloride | 50 | 50 | 0.0006 | 0.0012 | 2 | 12 |
| 2-11 | | | | | | | | |
| Example | Polyacrylic acid | Core: | 50 | 50 | 0.0006 | 0.0012 | 2 | 12 |
| 2-12 | | polyhexafluoropropylene | | | | | | |
| | | (Mw = 2.3 × 10⁵); Shell: | | | | | | |
| | | polyvinyl chloride (Mw = | | | | | | |
| | | 4.5 × 10⁴); Core-shell | | | | | | |
| | | mass ratio: 1:1 | | | | | | |

TABLE 4

| | | | | | Capacity | |
|---|---|---|---|---|---|---|
| | | | 10C | 10C | retention rate | |
| | F₁ | F₂ | charging | charging temperature | after 1000 cls at | Swelling |
| | (N/m) | (N/m) | speed (min) | rise (° C.) | 25° C. (%) | rate (%) |
| Example 1-1 | 8.1 | 12.3 | 15.32 | 18.72 | 85.2 | 8.3 |
| Example 2-1 | 8.2 | 9.2 | 15.31 | 18.77 | 83.0 | 9.0 |
| Example 2-2 | 8.3 | 13.6 | 15.35 | 18.72 | 82.7 | 8.3 |
| Example 2-3 | 8.1 | 8.2 | 15.32 | 18.71 | 77.7 | 14.1 |
| Example 2-4 | 8.4 | 15.4 | 17.37 | 19.70 | 75.3 | 8.1 |
| Example 2-5 | 7.3 | 12.1 | 15.38 | 18.73 | 84.6 | 9.5 |
| Example 2-6 | 9.8 | 12.3 | 16.12 | 18.99 | 82.1 | 7.8 |
| Example 2-7 | 3.7 | 12.2 | 15.36 | 18.76 | 78.7 | 16.2 |
| Example 2-8 | 10.2 | 12.5 | 17.08 | 19.82 | 77.4 | 7.9 |
| Example 2-9 | 8.2 | 12.2 | 15.48 | 18.98 | 84.2 | 8.7 |
| Example 2-10 | 8.1 | 12.3 | 15.33 | 18.91 | 85.1 | 8.2 |
| Example 2-11 | 8.4 | 12.5 | 15.58 | 18.88 | 83.8 | 8.6 |
| Example 2-12 | 8.5 | 12.0 | 15.59 | 19.02 | 83.9 | 8.5 |

The coverage rate Cr₁ of the first polymer binder in the first adhesive coating per unit area, the single-side coating weight Cw₁ of the first adhesive coating, and the thickness H₁ of the first adhesive coating generally affect the cycling kinetic performance and high-temperature stability of the secondary battery. From Example 1-1 and Examples 2-1 to 2-4, it can be seen that the secondary battery in which the coverage rate Cr₁ of the first polymer binder in the first adhesive coating per unit area, the single-side coating weight Cw₁ of the first adhesive coating, and the thickness H₁ of the first adhesive coating are within the ranges provided in the present application comprehensively has a shorter charging time, a lower charging temperature rise, and a higher capacity retention rate at a charging rate of 10 C, and has a lower swelling rate in thickness after storage at 85° C. for 8 h. Thus, the secondary battery can guarantee high-temperature stability while having good cycling kinetic performance under superfast charging conditions.

The coverage rate Cr₂ of the second polymer binder in the second adhesive coating per unit area, the single-side coating weight Cw₂ of the second adhesive coating, and the thickness H₂ of the second adhesive coating generally affect the cycling kinetic performance and high-temperature stability of the secondary battery. From Example 1-1 and Examples 2-5 to 2-8, it can be seen that the secondary battery in which the coverage rate Cr₂ of the second polymer binder in the second adhesive coating per unit area, the single-side coating weight Cw₂ of the second adhesive coating, and the thickness H₂ of the second adhesive coating are within the ranges provided in the present application comprehensively has a shorter charging time, a lower charging temperature rise, and a higher capacity retention rate at a charging rate of 10 C, and has a lower swelling rate in thickness after storage at 85° C. for 8 h. Thus, the secondary battery can guarantee high-temperature stability while having good cycling kinetic performance under superfast charging conditions.

The type of the first polymer binder generally affects the cycling kinetic performance and high-temperature stability of the secondary battery. From Example 1-1, Example 2-9, and Example 2-10, it can be seen that the secondary battery in which the type of the first polymer binder is within the ranges provided in the present application comprehensively has a shorter charging time, a lower charging temperature rise, and a higher capacity retention rate at a charging rate of 10 C, and has a lower swelling rate in thickness after storage at 85° C. for 8 h. Thus, the secondary battery can guarantee high-temperature stability while having good cycling kinetic performance under superfast charging conditions.

The type of the second polymer binder generally affects the cycling kinetic performance and high-temperature stability of the secondary battery. From Example 1-1, Example 2-11, and Example 2-12, it can be seen that the secondary battery in which the type of the second polymer binder is within the ranges provided in the present application comprehensively has a shorter charging time, a lower charging temperature rise, and a higher capacity retention rate at a charging rate of 10 C, and has a lower swelling rate in thickness after storage at 85° C. for 8 h. Thus, the secondary battery can guarantee high-temperature stability while having good cycling kinetic performance under superfast charging conditions.

TABLE 5

| | | | | | | | | Capacity | |
|---|---|---|---|---|---|---|---|---|---|
| | | | | | | | | retention | |
| | | | | | | | | rate | |
| | | | | | | 100 | 10C | after | |
| | Negative | | Positive | | | charging | charging | 1000 cls | |
| | electrode active | | active | F₁ | F₂ | speed | temperature | at 25° C. | Swelling |
| | material | I_{d}/I_{g} | material | (N/m) | (N/m) | (min) | rise (° C.) | (%) | rate (%) |
| Example | Artificial | 0.8 | Lithium | 8.1 | 12.3 | 15.32 | 18.72 | 85.2 | 8.3 |
| 1-1 | graphite + | | cobalt oxide | | | | | | |
| | amorphous | | | | | | | | |
| | carbon (N₁ = | | | | | | | | |
| | 92:8) | | | | | | | | |
| Example | Silicon-carbon | 0 | Lithium | 8.3 | 12.3 | 16.82 | 19.72 | 80.15 | 9.42 |
| 3-1 | material (mass | | cobalt oxide | | | | | | |
| | ratio of silicon | | | | | | | | |
| | to carbon: 5:95) | | | | | | | | |
| Example | Artificial | 0.2 | Lithium | 8.4 | 12.4 | 15.83 | 19.31 | 81.26 | 8.27 |
| 3-2 | graphite + | | cobalt oxide | | | | | | |
| | amorphous | | | | | | | | |
| | carbon (N₁ = | | | | | | | | |
| | 98:2) | | | | | | | | |
| Example | Artificial | 0.5 | Lithium | 8.2 | 12.1 | 15.53 | 19.04 | 83.24 | 8.22 |
| 3-3 | graphite + | | cobalt oxide | | | | | | |
| | amorphous | | | | | | | | |
| | carbon (N₁ = | | | | | | | | |
| | 95:5) | | | | | | | | |
| Example | Artificial | 1.0 | Lithium | 8.1 | 12.2 | 15.27 | 18.53 | 82.18 | 8.52 |
| 3-4 | graphite + | | cobalt oxide | | | | | | |
| | amorphous | | | | | | | | |
| | carbon (N₁ = | | | | | | | | |
| | 90:10) | | | | | | | | |
| Example | Artificial | 0.8 | Lithium iron | 8.3 | 12.5 | 15.57 | 18.83 | 83.14 | 8.53 |
| 3-5 | graphite + | | phosphate | | | | | | |
| | amorphous | | | | | | | | |
| | carbon (N₁ = | | | | | | | | |
| | 92:8) | | | | | | | | |
| Example | Artificial | 0.8 | Lithium | 8.2 | 12.1 | 15.42 | 18.96 | 82.33 | 8.77 |
| 3-6 | graphite + | | nickel cobalt | | | | | | |
| | amorphous | | manganese | | | | | | |
| | carbon (N₁ = | | oxide | | | | | | |
| | 92:8) | | (NCM811) | | | | | | |

Note:
The “\” in Table 5 indicates no corresponding parameter; and “N₁” in Table 5 represents a mass ratio of artificial graphite to amorphous carbon.

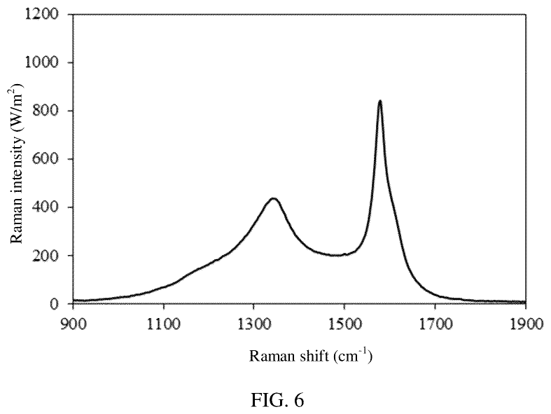

The type of the negative electrode active material and the I_{d}/I_{g} value of the carbon-based material generally affect the cycling kinetic performance and high-temperature stability of the secondary battery. From Example 1-1 and Examples 3-1 to 3-4, it can be seen that the secondary battery in which the type of the negative electrode active material and the I_{d}/I_{g} value of the carbon-based material are within the ranges provided in the present application comprehensively has a shorter charging time, a lower charging temperature rise, and a higher capacity retention rate at a charging rate of 10 C, and has a lower swelling rate in thickness after storage at 85° C. for 8 h. Thus, the secondary battery can guarantee high-temperature stability while having good cycling kinetic performance under superfast charging conditions. FIG. 6 shows a Raman spectrum of Example 3-3. From FIG. 6, it can be seen that in a Raman spectrum of a high-kinetic-performance negative electrode active material, the I_{d}/I_{g} value thereof is relatively high, indicating that the negative electrode active material has good surface activity.

The type of the positive electrode active material generally affects the cycling kinetic performance and high-temperature stability of the secondary battery. From Example 1-1, Example 3-5, and Example 3-6, it can be seen that the secondary battery in which the type of the positive electrode active material and the I_{d}/I_{g} value of the carbon-based material are within the ranges provided in the present application comprehensively has a shorter charging time, a lower charging temperature rise, and a higher capacity retention rate at a charging rate of 10 C, and has a lower swelling rate in thickness after storage at 85° C. for 8 h. Thus, the secondary battery can guarantee high-temperature stability while having good cycling kinetic performance under superfast charging conditions.

It should be noted that, in this specification, relational terms such as “first” and “second” are used merely to distinguish one entity or operation from another entity or operation, and do not necessarily require or imply that any such actual relationship or sequence exists between these entities or operations. Moreover, the terms “include”, “comprise”, or any other variant thereof are intended to cover non-exclusive inclusion, such that a process, method, article, or device that includes a series of elements includes not only those elements but also other elements not explicitly listed or inherent to such process, method, article, or device.

The various embodiments in this specification are all described in a related manner, and identical or similar parts of the various embodiments can refer to each other, with each embodiment focusing on differences from other embodiments.

The above descriptions are merely preferred embodiments of the present application and are not intended to limit the present application. Any modifications, equivalent substitutions, improvements, and the like made within the spirit and principles of the present application should fall within the protection scope of the present application.

What is claimed is:

1. A secondary battery, comprising an electrode assembly and an electrolyte, wherein the electrode assembly comprises a positive electrode sheet, a negative electrode sheet, and a separator; the positive electrode sheet comprises a positive electrode active material; the negative electrode sheet comprises a negative electrode active material; Dᵥ99 of the positive electrode active material is 27 μm to 33 μm; and Dᵥ99 of the negative electrode active material is 23 μm to 28 μm;
the separator comprises a separator substrate, a first adhesive coating, and a second adhesive coating; wherein the first adhesive coating and the second adhesive coating are respectively provided on two sides of the separator substrate;
the first adhesive coating comprises a first polymer binder, wherein an average particle size of the first polymer binder is 0.3 μm to 3 μm; and the second adhesive coating comprises a second polymer binder, wherein an average particle size of the second polymer binder is 10 μm to 38 μm;
the electrolyte comprises an organic solvent, a lithium salt, and an additive; wherein the organic solvent comprises a linear carboxylate ester; and
based on a mass of the electrolyte, a mass percentage of the linear carboxylate ester is 6% to 56%.

2. The secondary battery according to claim 1, wherein the Dᵥ99 of the positive electrode active material is 28 μm to 31 μm, and/or the Dᵥ99 of the negative electrode active material is 24 μm to 26 μm.

3. The secondary battery according to claim 1, wherein the average particle size of the first polymer binder is 0.6 μm to 1.6 μm; and/or the average particle size of the second polymer binder is 20 μm to 30 μm.

4. The secondary battery according to claim 1, wherein Dᵥ50 of the positive electrode active material is 10 μm to 15 μm, and Dᵥ50 of the negative electrode active material is 7 μm to 12 μm.

5. The secondary battery according to claim 1, wherein the first adhesive coating is provided on a side of the separator substrate facing the negative electrode sheet, and the second adhesive coating is provided on a side of the separator substrate facing the positive electrode sheet.

6. The secondary battery according to claim 1, wherein a thickness of the first adhesive coating is 0.2 μm to 4 μm, and a thickness of the second adhesive coating is 5 μm to 20 μm.

7. The secondary battery according to claim 1, wherein a single-side coating weight of the first adhesive coating is 0.0001 mg/mm² to 0.001 mg/mm², and a single-side coating weight of the second adhesive coating is 0.0004 mg/mm² to 0.002 mg/mm².

8. The secondary battery according to claim 1, wherein a coverage rate of the first polymer binder in the first adhesive coating per unit area is 40% to 60%.

9. The secondary battery according to claim 1, wherein the first polymer binder is a core-shell structure, and the first polymer binder comprises a first shell and a first core; wherein a polymerization monomer of the first shell comprises at least one of methyl acrylate, ethyl acrylate, butyl acrylate, methyl methacrylate, ethyl methacrylate, butyl methacrylate, ethylene, ethyl chloromethyl acrylate, chlorostyrene, fluorostyrene, methylstyrene, acrylonitrile, or methacrylonitrile; and a polymerization monomer of the first core comprises at least one of ethyl acrylate, butyl acrylate, ethyl methacrylate, styrene, chlorostyrene, fluorostyrene, methylstyrene, acrylic acid, methacrylic acid, or maleic acid; or
the first polymer binder is a non-core-shell structure, wherein a polymerization monomer of the first polymer binder comprises at least one of acrylic acid, methyl acrylate, butyl acrylate, butadiene, styrene, acrylonitrile, ethylene, fluorostyrene, chlorostyrene, or propylene.

10. The secondary battery according to claim 1, wherein a coverage rate of the second polymer binder in the second adhesive coating per unit area is 40% to 60%.

11. The secondary battery according to claim 1, wherein the second polymer binder is a core-shell structure, and the second polymer binder comprises a second shell and a second core; wherein a polymerization monomer of the second shell comprises at least one of vinylidene chloride, vinylidene fluoride, hexafluoropropylene, styrene, butadiene, acrylonitrile, acrylic acid, methyl acrylate, or butyl acrylate, and a polymerization monomer of the second core comprises at least one of ethyl methacrylate, methyl acrylate, ethyl acrylate, butyl acrylate, methyl methacrylate, butyl methacrylate, or ethyl chloromethyl acrylate; or
the second polymer binder is a non-core-shell structure, wherein a polymerization monomer of the second polymer binder comprises at least one of vinylidene chloride, vinylidene fluoride, hexafluoropropylene, ethylene, propylene, vinyl chloride, chloropropene, acrylic acid, methyl acrylate, butyl acrylate, styrene, butadiene, or acrylonitrile.

12. The secondary battery according to claim 1, wherein the linear carboxylate ester comprises at least one of methyl formate, methyl acetate, ethyl formate, ethyl acetate, propyl acetate, ethyl propionate, n-propyl propionate, isopropyl propionate, methyl propionate, n-butyl propionate, isobutyl propionate, n-pentyl propionate, isopentyl propionate, ethyl butyrate, n-propyl butyrate, propyl isobutyrate, n-pentyl butyrate, n-pentyl isobutyrate, n-butyl butyrate, isobutyl isobutyrate, or n-pentyl valerate.

13. The secondary battery according to claim 1, wherein based on the mass of the electrolyte, a mass percentage of the linear carboxylate ester is 18% to 40%.

14. The secondary battery according to claim 1, wherein the organic solvent further comprises at least one of ethylene carbonate, propylene carbonate, dimethyl carbonate, diethyl carbonate, methyl ethyl carbonate, γ-butyrolactone, or tetrahydrofuran; and
based on the mass of the electrolyte, a mass percentage of the organic solvent is 60% to 90%.

15. The secondary battery according to claim 1, wherein the additive comprises at least one of succinonitrile, glutaronitrile, pimelonitrile, 1,2-bis(2-cyanoethoxy)ethane, 1,2-bis(2-cyanoethoxy)propane, or 1,2-(3-cyanopropoxy)ethane; and
based on the mass of the electrolyte, a mass percentage of the additive is 2% to 20%.

16. The secondary battery according to claim 1, wherein the negative electrode active material comprises at least one of a carbon-based material, a silicon-based material, or a tin-based material; wherein the carbon-based material comprises at least one of natural graphite, artificial graphite, soft carbon, hard carbon, or mesocarbon microbeads; the silicon-based material comprises at least one of elemental silicon, a silicon-carbon material, or a silicon-oxygen material; and the tin-based material comprises at least one of elemental tin, tin alloy, or tin oxide.

17. The secondary battery according to claim 16, wherein the negative electrode active material comprises the carbon-based material; and a peak intensity ratio I_{d}/I_{g} of peak d to peak g in a Raman test of the carbon-based material satisfies: 0.2≤I_{d}/I_{g}≤1.0.

18. The secondary battery according to claim 1, wherein the positive electrode active material comprises at least one of lithium nickel cobalt manganese oxide, lithium nickel cobalt aluminum oxide, lithium iron phosphate, a lithium-rich manganese-based material, lithium cobalt oxide, lithium manganese oxide, lithium manganese iron phosphate, or lithium titanate.

19. The secondary battery according to claim 18, wherein the positive electrode active material further comprises a non-metal element; and the non-metal element comprises at least one of fluorine, phosphorus, boron, chlorine, silicon, or sulfur.

20. An electric apparatus, comprising the secondary battery according to claim 1.
